(19) United States
(12) Patent Application Publication
(10) Pub. No.: US 2023/0225377 A1
(43) Pub. Date: Jul. 20, 2023

(54) TOFU TRANSFER MECHANISM AND TOFU CONTINUOUS PRODUCTION DEVICE

(71) Applicant: TAKAI TOFU & SOYMILK EQUIPMENT CO., Ishikawa (JP)

(72) Inventors: Toichiro TAKAI, Ishikawa (JP); Masahide TAKEDA, Ishikawa (JP); Kazuyuki SHIGA, Ishikawa (JP)

(73) Assignee: TAKAI TOFU & SOYMILK EQUIPMENT CO., Ishikawa (JP)

(21) Appl. No.: 17/998,150

(22) PCT Filed: Apr. 30, 2021
(86) PCT No.: PCT/JP2021/017306

§ 371 Date: Nov. 7, 2022

(30) Foreign Application Priority Data
May 8, 2020 (JP) 2020-082738

(51) Int. Cl. A23L 11/45; B65G 47/66; B65G 15/22

(52) U.S. Cl. CPC A23L 11/45; B65G 47/66; B65G 15/22; B65G 2201/0202

(57) ABSTRACT

A tofu transfer mechanism is configured to transfer tofu from a first production device to a second production device in a tofu continuous production device. The tofu transfer mechanism includes: a transfer member disposed so as to bridge a terminal end of the first production device and a starting end of the second production device, the starting end of the second production device facing the terminal end of the first production device; and a folding-back guide unit configured to guide an endless conveyor of the second production device at the starting end of the second production device such that the endless conveyor of the second production device is bent downward at an acute angle with respect to a conveyance surface on which the tofu is conveyed.

### TECHNICAL FIELD

The present invention relates to a tofu transfer mechanism that is applied to a production device for continuously producing tofu.

### BACKGROUND ART

In related art, in order to produce tofu by coagulating soymilk, the tofu is produced by using a mold box in low-volume production, but in mass production, the tofu is continuously formed and produced without using the mold box such that the soymilk is coagulated while being conveyed by a conveyor. After forming, the tofu is cut into a predetermined size and then stored in packs. Various devices have already been provided as such tofu continuous production devices.

Many of the tofu continuous production devices in the related art include at least two conveyors, that is, a primary conveyor and a secondary conveyor, and further include a transfer mechanism that transfers the tofu from the primary conveyor to the secondary conveyor.

### CITATION LIST

### Patent Literature

Patent Literature 1: JP2983085B2
Patent Literature 2: JPS 52-005583B2
Patent Literature 3: JP3568193B2
Patent Literature 4: JPH03-251151A
Patent Literature 5: JP2018-198593 A

### SUMMARY OF INVENTION

### Technical Problem

In the devices in the related art, a length of a transfer plate used in the transfer mechanism (a length of the tofu in a traveling direction) is long, which inevitably leads to an increase in a size of the continuous production device. For example, when sheet-shaped tofu transferred from a continuous coagulation machine on a primary conveyor side does not slide well, the device is likely to be clogged with the tofu at the transfer mechanism and thus a trouble is likely to occur. In order to solve such a problem, the device in the related art adopts a structure in which water is sprayed from a bottom side to cause the tofu to slide easily, or adopts a structure in which a difference in height between the primary conveyor and the secondary conveyor is increased to create a downward slope. However, the variation of properties of the tofu may cause the tofu to slide too much to crack and to break down during transferring, or not to slide and accumulate, which may require time and effort for frequent adjustment of the sprayed water or the like.

The present invention provides a tofu transfer mechanism and a tofu continuous production device that can be reduced in size and can prevent a trouble related to transferring of tofu.

### Solution to Problem

A tofu transfer mechanism according to an aspect of the present invention is a tofu transfer mechanism configured to transfer tofu from a first production device to a second production device in a tofu continuous production device, the tofu transfer mechanism including: a transfer member disposed so as to bridge a terminal end of the first production device and a starting end of the second production device, the starting end of the second production device facing the terminal end of the first production device; and a folding-back guide unit configured to guide an endless conveyor of the second production device at the starting end of the second production device such that the endless conveyor of the second production device is bent downward at an acute angle with respect to a conveyance surface on which the tofu is conveyed.

In the tofu transfer mechanism of the present invention, for example, the folding-back guide unit includes: a folding-back unit configured to bend the endless conveyor of the second production device downward; and a folding-back assisting unit disposed farther from the terminal end of the first production device than the folding-back unit and disposed below the folding-back unit. The endless conveyor of the second production device bent by the folding-back unit is bridged over the folding-back assisting unit, so that the acute angle is maintained at a bent portion of the endless conveyor of the second production device at the folding-back unit.

In the tofu transfer mechanism of the present invention, for example, an angle α formed by the conveyance surface of the endless conveyor of the second production device and a virtual plane is 90°<α<270°, where the virtual plane is defined as a plane obtained by rotating a folding-back surface by 180 degrees about the folding-back unit, the folding-back surface extending from the folding-back unit toward the folding-back assisting unit.

In the tofu transfer mechanism of the present invention, for example, the folding-back unit includes a rotating roller or a fixing member.

In the tofu transfer mechanism of the present invention, for example, a cross-sectional shape of the rotating roller is circular or polygonal.

In the tofu transfer mechanism of the present invention, for example, the fixing member has a cross-sectional shape including at least a circular arc.

In the tofu transfer mechanism of the present invention, for example, each of both ends of the folding-back unit has a tapered shape.

In the tofu transfer mechanism of the present invention, for example, a conveyor of the first production device includes any one of a metal belt, a Teflon belt, and a food belt.

In the tofu transfer mechanism of the present invention, for example, the endless conveyor of the second production device includes any one of a resin filter fabric belt, a Teflon belt, a food belt, and a wire net belt.

In the tofu transfer mechanism of the present invention, for example, a hardness of the tofu transferred from the first production device is 1 kN/m² to 100 kN/m².

The Tofu Transfer Mechanism.

A tofu continuous production device of the present invention includes the above tofu transfer mechanism, the first production device, and the second production device.

In the tofu continuous production device of the present invention, for example, a rearmost end of the first production device and a foremost end of the second production device at the folding-back unit are close to each other in a horizontal direction or in contact with each other in the horizontal direction, or overlap with each other in the horizontal direction.

The tofu continuous production device of the present invention further includes, for example, a cutting device on the first production device, and the tofu is cut and then transferred to the endless conveyor of the second production device.

A tofu transfer mechanism according to an aspect of the present invention is a tofu transfer mechanism configured to transfer tofu from a first production device to a second production device in a tofu continuous production device, the tofu transfer mechanism including: a transfer member disposed so as to bridge a terminal end of the first production device and a starting end of the second production device, the starting end of the second production device facing the terminal end of the first production device; and a folding-back guide unit configured to guide an endless conveyor of the first production device at the terminal end of the first production device such that the endless conveyor of the first production device is bent downward at an acute angle with respect to a conveyance surface on which the tofu is conveyed.

In the tofu transfer mechanism of the present invention, for example, the folding-back guide unit includes: a folding-back unit configured to bend the endless conveyor of the first production device downward; and a folding-back assisting unit disposed farther from the starting end of the second production device than the folding-back unit and disposed below the folding-back unit. The endless conveyor of the first production device bent by the folding-back unit is bridged over the folding-back assisting unit, so that the acute angle is maintained at a bent portion of the endless conveyor of the first production device at the folding-back unit.

In the tofu transfer mechanism of the present invention, for example, an angle α formed by the conveyance surface of the endless conveyor of the first production device and a virtual plane is 90°<α<270°, where the virtual plane is defined as a plane obtained by rotating a folding-back surface by 180 degrees about the folding-back unit, the folding-back surface extending from the folding-back unit toward the folding-back assisting unit.

In the tofu transfer mechanism of the present invention, for example, the folding-back unit includes a rotating roller or a fixing member.

In the tofu transfer mechanism of the present invention, for example, a cross-sectional shape of the rotating roller is circular or polygonal.

In the tofu transfer mechanism of the present invention, for example, the fixing member has a cross-sectional shape including at least a circular arc.

In the tofu transfer mechanism of the present invention, for example, each of both ends of the folding-back unit has a tapered shape.

In the tofu transfer mechanism of the present invention, for example, a conveyor of the second production device includes any one of a metal belt, a Teflon belt, a food belt, and a wire net belt.

In the tofu transfer mechanism of the present invention, for example, a conveyor of the second production device is configured to convey the tofu in a direction intersecting with a tofu conveying direction of the first production device.

In the tofu transfer mechanism of the present invention, for example, the endless conveyor of the first production device includes any one of a resin filter fabric belt, a Teflon belt, a food belt, and a wire net belt.

In the tofu transfer mechanism of the present invention, for example, a hardness of the tofu transferred from the first production device is 1 kN/m² to 100 kN/m².

The Tofu Transfer Mechanism.

A tofu continuous production device of the present invention includes the above tofu transfer mechanism, the first production device, and the second production device.

In the tofu continuous production device of the present invention, for example, a rearmost end of the first production device at the folding-back unit and a foremost end of the second production device are close to each other in a horizontal direction or in contact with each other in the horizontal direction, or overlap with each other in the horizontal direction.

The tofu continuous production device of the present invention further includes, for example, a cutting device on the first production device, and the tofu is cut and then transferred to an endless conveyor of the second production device.

The present invention is a tofu continuous production device including:

a first production device including an endless conveyor; and

a second production device including an endless conveyor,

wherein the tofu continuous production device is configured to transfer tofu from the first production device to the second production device, and

wherein the tofu continuous production device further includes, a folding-back guide unit at an end of the production device, the end of the production device being one of a terminal end of the first production device and a starting end of the second production device, the starting end of the second production device facing the terminal end of the first production device, the folding-back guide unit being configured to guide the endless conveyor of the production device such that the endless conveyor of the production device is bent downward at an acute angle with respect to a conveyance surface on which the tofu is conveyed.

The tofu continuous production device of the present invention further includes, for example, a transfer member disposed so as to bridge the terminal end of the first production device and the starting end of the second production device.

In the tofu continuous production device of the present invention, for example, the folding-back guide unit includes:

a folding-back unit configured to bend the endless conveyor of the second production device downward; and

a folding-back assisting unit disposed farther from the terminal end of the first production device than the folding-back unit and disposed below the folding-back unit, and

the endless conveyor of the second production device bent by the folding-back unit is bridged over the folding-back assisting unit, so that the acute angle is maintained a bent portion of the endless conveyor of the second production device at the folding-back unit.

In the tofu continuous production device of the present invention, for example, the folding-back guide unit is provided at the starting end of the second production device,

the first production device is a continuous coagulation machine in which the endless conveyor includes any one of a metal belt, a Teflon belt, and a food belt, and

the second production device is any one of a continuous forming machine, a cutting machine, a conveying machine, and a distribution and alignment machine in which the endless conveyor includes any one of a resin filter fabric belt, a Teflon belt, a food belt, and a wire net belt.

In the tofu continuous production device of the present invention, for example, the folding-back guide unit is provided at the terminal end of the first production device,

the first production device is a continuous forming machine in which the endless conveyor includes any one of a resin filter fabric belt, a Teflon belt, a food belt, and a wire net belt, and

the second production device is any one of a cutting machine, a conveying machine, and a distribution and alignment machine in which the endless conveyor includes any one of a resin filter fabric belt, a Teflon belt, a food belt, and a wire net belt.

The tofu continuous production device of the present invention further includes, for example, a third production device including an endless conveyor,

wherein the tofu is transferred from the second production device to the third production device, and

wherein the tofu continuous production device further includes another folding-back guide unit at an end of the production device, the end of the production device being one of a terminal end of the second production device and a starting end of the third production device, the starting end of the third production device facing the terminal end of the second production device, the another folding-back guide unit being configured to guide the endless conveyor of the production device such that the endless conveyor of the production device is bent downward at an acute angle with respect to a conveyance surface on which the tofu is conveyed.

In the tofu continuous production device of the present invention, for example, the folding-back guide unit is provided at the starting end of the second production device, and the another folding-back guide unit is provided at the terminal end of the second production device,

the first production device is a continuous coagulation machine in which the endless conveyor includes any one of a metal belt, a Teflon belt, and a food belt,

the second production device is a continuous forming machine, a cutting machine, a conveying machine, or a distribution and alignment machine in which the endless conveyor includes any one of a resin filter fabric belt, a Teflon belt, a food belt, and a wire net belt, and

the third production device is any one of a cutting machine, a conveying machine, and a distribution and alignment machine in which the endless conveyor includes any one of a resin filter fabric belt, a Teflon belt, a food belt, and a wire net belt.

### Advantageous Effects of Invention

According to a tofu transfer mechanism of the present invention, a reduction in size is possible, and a trouble related to transferring of tofu can be prevented.

### BRIEF DESCRIPTION OF DRAWINGS

FIG. 1 shows a side view of a tofu continuous production device in which a steel belt type continuous coagulation machine is used, (a) of FIG. 1 shows a tofu continuous production device in related art, and (b) of FIG. 1 shows a tofu continuous production device according to one embodiment of the present invention.

FIG. 2 shows a side view of a tofu continuous production device in which a food belt type continuous coagulation machine is used, (a) of FIG. 2 shows a tofu continuous production device in the related art, and (b) of FIG. 2 shows a tofu continuous production device according to one embodiment of the present invention.

FIG. 3 shows an enlarged view of a region in which tofu is transferred from a right side to a left side in a drawing sheet and that includes a terminal end of a continuous coagulation machine, a starting end of a continuous forming machine, and a tofu transfer mechanism, (a) of FIG. 3 is an enlarged view of the device in the related art, and (b) of FIG. 3 is an enlarged view of the tofu continuous production device according to the embodiment of the present invention.

FIG. 4 shows an enlarged view of a region in which the tofu is transferred from the right side to the left side or from the left side to the right side in the drawing sheet and that includes the terminal end of the continuous coagulation machine, the starting end of the continuous forming machine, and the tofu transfer mechanism, (a) of FIG. 4 is an enlarged view of a tofu continuous production device according to another embodiment, and (b) of FIG. 4 is an enlarged view of a tofu continuous production device according to still another embodiment.

FIG. 5 is an enlarged view illustrating a folding-back unit, (a) of FIG. 5 shows an enlarged view of the folding-back unit implemented by a rotating roller, and (b) of FIG. 5 shows an enlarged view of the folding-back unit implemented by a fixing member.

(a) to (c) of FIG. 6 are enlarged views of various embodiments of the folding-back unit implemented by the rotating roller.

(a) to (c) of FIG. 7 are enlarged views of various embodiments of the folding-back unit implemented by the fixing member.

FIG. 8 is views of various embodiments of the folding-back unit implemented by the rotating roller, (a) of FIG. 8 shows a view equivalent to (a) of FIG. 5, (b) of FIG. 8 is a plan view when viewed from an arrow direction in (a) of FIG. 8, and (c) of FIG. 8 is a plan view when viewed from the arrow direction in (a) of FIG. 8.

FIG. 9 is views of various embodiments of the folding-back unit implemented by the fixing member, (a) of FIG. 9 shows a view equivalent to (b) of FIG. 5, (b) of FIG. 9 is a plan view when viewed from an arrow direction in (a) of FIG. 9, and (c) of FIG. 9 is a plan view when viewed from the arrow direction in (a) of FIG. 9.

(a) to (f) of FIG. 10 show various embodiments of a cross-sectional shape of the folding-back unit implemented by the rotating roller.

(a) to (m) of FIG. 11 show various embodiments of a cross-sectional shape of the folding-back unit implemented by the fixing member.

FIG. 12 shows a tofu continuous production device according to another embodiment of the present invention.

FIG. 13 shows a tofu continuous production device according to another embodiment of the present invention.

FIG. 14 shows a tofu continuous production device according to another embodiment of the present invention, (a) of FIG. 14 shows a plan view, and (b) of FIG. 14 shows a side view.

FIG. 15 shows a tofu continuous production device in the related art.

(a) to (c) of FIG. 16 each show a tofu continuous production device according to another embodiment of the present invention.

FIG. 17 shows a tofu continuous production device according to another embodiment of the present invention, (a) of FIG. 17 shows a plan view, and (b) of FIG. 17 shows a side view.

FIG. 18 shows a tofu continuous production device according to another embodiment of the present invention, (a) of FIG. 18 shows a plan view, and (b) of FIG. 18 shows a side view.

FIG. 19 shows a tofu continuous production device according to another embodiment of the present invention, (a) of FIG. 19 shows a plan view, and (b) of FIG. 19 shows a side view.

### DESCRIPTION OF EMBODIMENTS

Hereinafter, embodiments of a tofu transfer mechanism and a tofu continuous production device according to the present invention will be described in detail with reference to drawings.

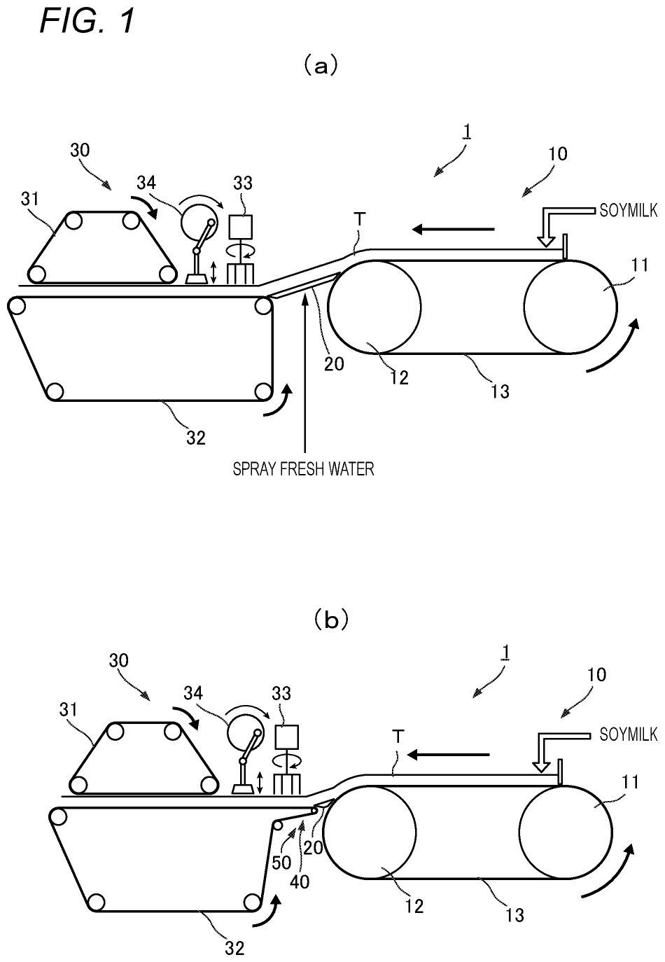

FIG. 1 shows a side view of a tofu continuous production device, and particularly, (a) of FIG. 1 shows a tofu continuous production device 1 in related art and (b) of FIG. 1 shows a tofu continuous production device 1 according to one embodiment of the present invention. The tofu continuous production device 1 is a device for continuously forming and producing tofu by coagulating injected soymilk while conveying the soymilk by a conveyor, and includes a continuous coagulation machine 10, a continuous forming machine 30, and a transfer member 20. As illustrated, the soymilk injected into the continuous coagulation machine 10 becomes sheet-shaped tofu T while being coagulated, is conveyed by a conveyor 13 driven by drive rollers 11 and 12, and is conveyed toward the continuous forming machine 30. The continuous coagulation machine 10 in FIG. 1 is a steel belt type continuous coagulation machine.

In the continuous production device 1 of the present embodiment, the continuous coagulation machine 10 in the related art is used, but each of the transfer member 20 and the continuous forming machine 30 has a new configuration.

The tofu to be produced by the tofu continuous production device 1 is, for example, a curd for thick deep-fried tofu, a curd for a tofu cutlet, a curd for deep-fried tofu, a curd for a deep-fried tofu burger, a curd for cotton tofu, a curd for soft cotton tofu, a curd for grilled tofu, a curd for dried-frozen tofu, a curd for a dried-frozen tofu cutlet, a curd for a dried-frozen silken tofu cutlet, or the like, but is not particularly limited. As used herein, the term “Tofu” is referred to as a concept that includes not only the sheet-shaped tofu T but also block-shaped tofu and a cake of tofu which are obtained by cutting the sheet-shaped tofu T.

The sheet-shaped tofu T conveyed from the continuous coagulation machine 10 is transferred to the plate-shaped transfer member 20 in the same direction, and the transfer member 20 transfers the sheet-shaped tofu T to the continuous forming machine 30 that conveys the sheet-shaped tofu T in the same direction. That is, a rotation center axis of each of the drive rollers 11 and 12 of the continuous coagulation machine 10 is parallel to a center axis of each of rollers of the continuous forming machine 30, and the drive rollers 11 and 12 of the continuous coagulation machine 10 and the rollers of the continuous forming machine 30 rotate in the same direction when the sheet-shaped tofu T is conveyed.

Conveying speeds of conveyance surfaces of the continuous coagulation machine 10 and the continuous forming machine 30 are usually the same, but may be relatively different depending on conditions.

The continuous forming machine 30 includes an upper endless conveyor 31, a lower endless conveyor 32, a crushing device 33, and a leveling device 34. The sheet-shaped tofu T is first conveyed by the lower endless conveyor 32, crushed to a predetermined size by the crushing device 33, leveled to a uniform height by the leveling device 34, and naturally dehydrated without load. Thereafter, the crushed and leveled tofu is further dehydrated while being sandwiched between the upper endless conveyor 31 and the lower endless conveyor 32 in an up-and-down direction, and is conveyed to a downstream process. The above description is common to the devices in (a) of FIG. 1 and (b) of FIG. 1.

Instead of a steel belt type, the endless conveyor 13 of the continuous coagulation machine 10 may be a rigid metal belt that is made of stainless steel, titanium, or the like, and that includes, at both ends, side walls made of flexible silicone rubber (for example, see JP3568193B2 or the like), or the endless conveyor 13 may be a food belt made of a resin whose surface is to be in contact with food and that includes a lower belt and side wall belts. In the food belt, a canvas made of a resin such as a polyester, or a wire made of metal is used as a core material, and a flexible resin such as a urethane resin or a vinyl chloride resin, or rubber is laminated and welded on a surface of the core material. Further, the endless conveyor 13 may be a Teflon belt in which aramid fibers are coated with a fluorine resin (for example, see JP4512663B1, JP4613252B1, or the like).

As in a case of a steel belt, a diameter of the drive roller 12 at a rear end (the drive roller 11 at a front end in some cases) is set to a large diameter within a range of 300 mmφ to 1500 mmφ, preferably 500 mmφ to 1000 mmφ. In a case of the Teflon belt or the food belt, a diameter of the drive roller 12 at the rear end (the drive roller 11 at the front end in some cases) is 50 mm or more and preferably 50 mm to 300 mm, which is smaller than that in the case of the steel belt, but a larger diameter is advantageous because slipping can be prevented.

As the endless conveyor 32 of the continuous forming machine 30, there is used a resin filter fabric belt that is flat-wound at starting and rear ends and forms a bottom surface and side walls on a conveyance surface, a wire net belt (a glasses link belt conveyor, a flat flex conveyor, a chocolate conveyor, or the like) in which a wire made of metal such as stainless steel is woven, a perforated or non-perforated food resin belt (a Teflon belt or a food belt), or the like. The resin filter fabric belt is a resin filter fabric in which monofilaments of a fluorine resin, a polyester resin, a polypropylene resin, a polyethylene resin, or the like are woven into a plain weave, a twill weave, or the like (for example, see JP4004413B2 or the like). The endless conveyor 32 is not particularly limited as long as a material or form is a flexible and tough material capable of forming a knife-edge-shaped folding-back unit 42 whose diameter (thickness) is 5 mm or more and less than 50 mm (preferably 10 mm to 30 mm). Further, the endless conveyor 32 may be flat-wound at the starting and terminal ends, and may be vertically folded back at both ends on the conveyance surface as vertical walls are formed at both ends of a caterpillar that rotates on an inner side of the conveyor and supports the filter fabric on the conveyance surface (see, for example, JPH05-000089U, JP4269319B2, or the like).

The transfer member 20 is a plate-shaped member made of stainless steel or a resin, and in particular, a front end thereof is formed to be sharp in a tapered shape, and a tip member made of a resin may be provided, for example, at a front end of a stainless steel plate so as to be in contact with the steel belt. The transfer member 20 preferably has a shape that allows the tofu to be transferred from the continuous coagulation machine 10 without being damaged. Further, it is preferable that a rear end of the transfer member 20 is also formed to be sharp in a tapered shape.

The transfer member 20 is formed by members having a round bar shape, a triangular cross section, a hexagonal cross section, or the like in addition to the plate shape (for example, bars having a cross section shown in each of FIGS. 10 and 11 that shows the folding-back unit to be described later), may be a form in which the plurality of these members are arranged side by side, a form of a knife edge type belt conveyor, or a form in which the members rotate automatically or freely (a roller type, a belt conveyor type, or the like), and is not particularly limited as long as the transfer member 20 is a member that does not easily hinder transferring.

The sheet-shaped tofu T is, for example, sheet-shaped silken tofu, and is transferred from the continuous coagulation machine 10 to the continuous forming machine 30 while keeping a silken shape (silk tofu, soft tofu or the like). Further, the sheet-shaped tofu T may be coarsely crushed tofu (the cotton tofu, the soft cotton tofu, the grilled tofu, a curd for the tofu cutlet, a curd for the thick deep-fried tofu, or the like) coarsely crushed as appropriate by a crushing device which is provided, for example, in the vicinity of a terminal end of the continuous coagulation machine 10, on the transfer member 20, or in the vicinity of a starting end of the continuous forming machine 30. The crushing device may be provided for any of coarse crushing, medium crushing, and fine crushing, and a leveling device may be provided after the crushing device.

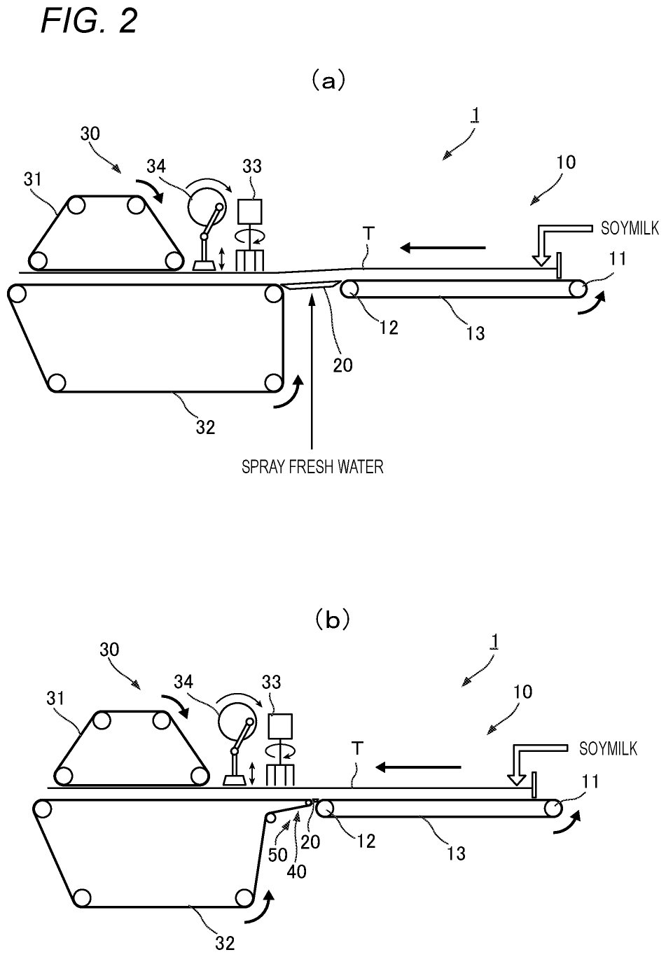

FIG. 2 shows a side view of a tofu continuous production device, and particularly, (a) of FIG. 2 shows a tofu continuous production device 1 in the related art and (b) of FIG. 2 shows a tofu continuous production device 1 according to one embodiment of the present invention. The continuous coagulation machine 10 in FIG. 2 is a food belt type continuous coagulation machine. The other configurations are the same as those in FIG. 1.

Next, the plate-shaped transfer member 20 common to FIG. 1 and FIG. 2 will be described. The transfer member 20 is disposed so as to bridge the terminal end of the continuous coagulation machine 10 and the starting end of the continuous forming machine 30 that faces the terminal end of the continuous coagulation machine 10. In the device in the related art shown in each of (a) of FIG. 1 and (a) of FIG. 2, water (fresh water) is sprayed onto the transfer member 20, and the sheet-shaped tofu T is transferred from the continuous coagulation machine 10 to the continuous forming machine 30 while sliding on the transfer member 20.

As illustrated, in the device in the related art, a length of the transfer member 20 is long (for example, 500 mm or more), and when the sheet-shaped tofu transferred from the continuous coagulation machine 10 does not slide well, the device is likely to be clogged with the tofu at the transfer member 20 and thus a trouble is likely to occur. In order to solve such a problem, a structure is used in which the water is sprayed in a small amount to cause the tofu to slide easily, or a difference in height between the continuous coagulation machine 10 and the continuous forming machine 30 is increased to create a downward slope. However, when properties of the tofu change, the tofu slides too much to crack and to break down during transferring, or the tofu does not slide and accumulates, and thus time and effort is required for frequent adjustment of the sprayed water or the like.

Since the device is a large-scale machine, for positions (positions in a front-and-rear direction and the up-and-down direction) of the continuous coagulation machine 10, the transfer member 20, the continuous forming machine 30, and a next process device (a cutting device or the like), installation positions initially set and a layout determined during test operation are often directly used. However, when the installation positions and the layout are inappropriate, it is difficult to change the installation positions and the layout later and a lot of effort is required at the time of changing, and thus a quality adjustment range for the tofu tends to be limited.

On the other hand, the tofu continuous production device 1 of the present embodiment shown in each of (b) of FIG. 1 and (b) of FIG. 2 includes a folding-back guide unit 40 that guides the lower endless conveyor 32 of the continuous forming machine 30 at the starting end of the continuous forming machine 30 such that the lower endless conveyor 32 of the continuous forming machine 30 is bent downward at an acute angle with respect to the conveyance surface on which the sheet-shaped tofu T is conveyed. The folding-back guide unit 40 and the transfer member 20 cooperate to constitute a tofu transfer mechanism 50 that smoothly transfers the sheet-shaped tofu T.

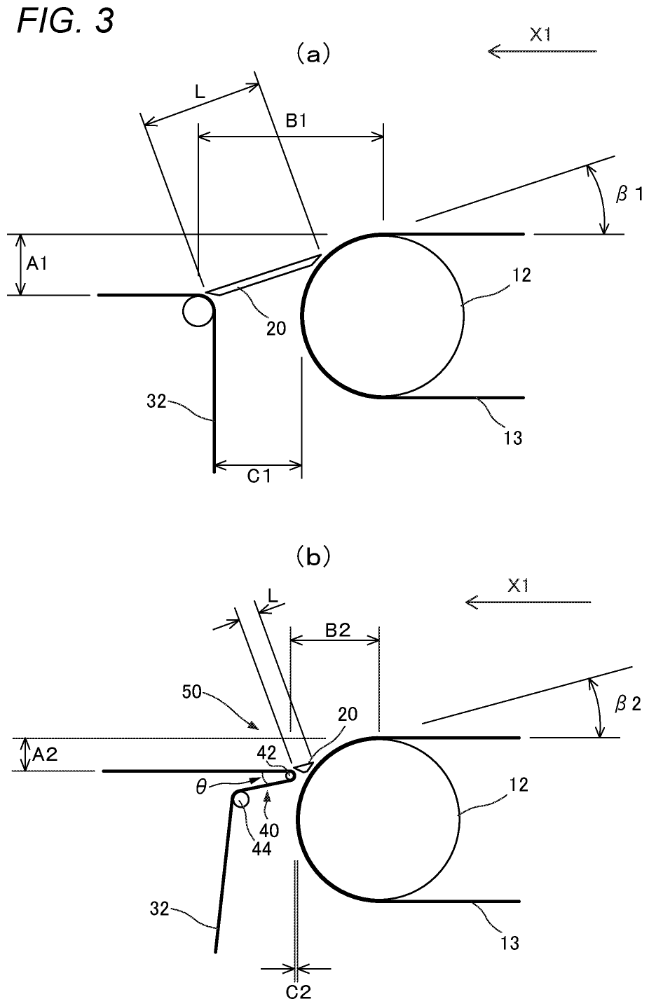

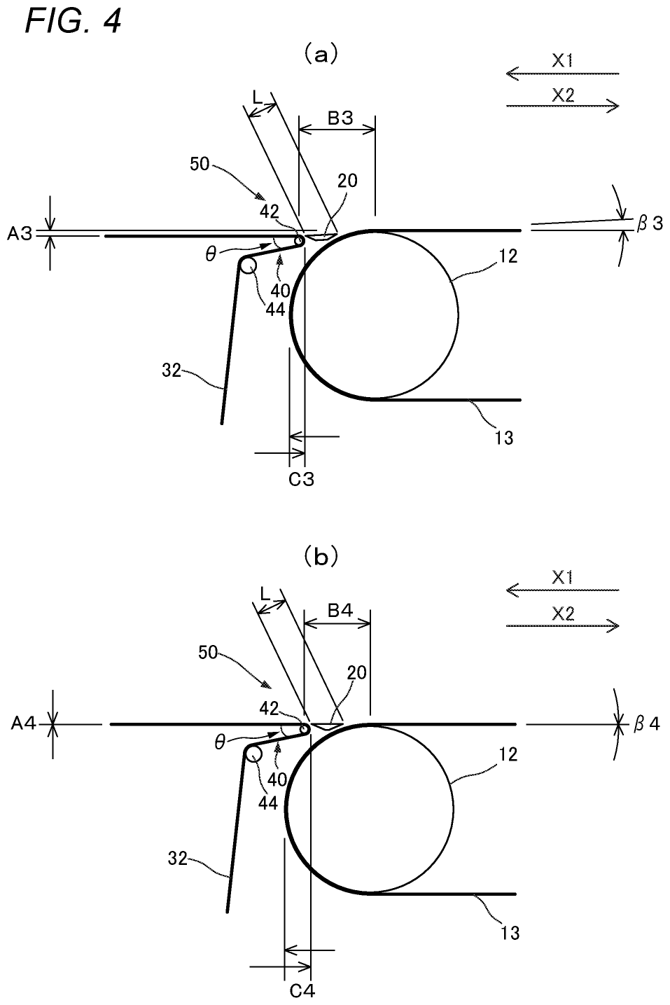

FIG. 3 and FIG. 4 are each an enlarged view of a region including the terminal end of the continuous coagulation machine 10, the starting end of the continuous forming machine 30, and the tofu transfer mechanism 50 in FIG. 1 and FIG. 2. (a) of FIG. 3 is the enlarged view of the device in the related art, and (b) of FIG. 3, (a) of FIG. 4, and (b) of FIG. 4 are the enlarged views of various embodiments of the tofu transfer mechanism 50. The tofu transfer mechanism 50 in each of (b) of FIG. 3, (a) of FIG. 4, and (b) of FIG. 4 includes the transfer member 20 and the folding-back guide unit 40. The device in each of (a) of FIG. 3 and (b) of FIG. 3 transfers the tofu from a right side to a left side in a drawing sheet as shown by an arrow X1. A device in each of (a) of FIG. 4 and (b) of FIG. 4 transfers the tofu as shown by the arrow X1 in the device shown in a respective one of FIG. 1 and FIG. 2, but can also transfer the tofu from the left side to the right side in the drawing sheet as shown by an arrow X2 of an opposite direction.

In each embodiment, the folding-back guide unit 40 includes the folding-back unit 42 and a folding-back assisting unit 44. The folding-back unit 42 is implemented by a rotating roller or a fixed fixing member, and serves to bend the lower endless conveyor 32 downward. The folding-back assisting unit 44 is implemented by a rotating roller or a fixed fixing member, and is disposed farther from the terminal end of the continuous coagulation machine 10 than the folding-back unit 42 and disposed below the folding-back unit 42. The folding-back unit 42 is in contact with and guides a back surface of the conveyance surface of the endless conveyor 32, while the folding-back assisting unit 44 is in contact with and guides the conveyance surface of the endless conveyor 32 of the continuous forming machine 30.

In order to shorten a sliding distance of the tofu, a shorter length L of the transfer member 20 in the front-and-rear direction is more preferable, and it is ideal that as an extreme instance, L=0, that is, the transfer member 20 does not exist. For example, when the diameter of the drive roller 12 at the rear end is 500 mm to 1000 mm, and the diameter (the thickness) of the folding-back unit 42 is 51 mm or more to 200 mm in an example in the related art and is 5 mm to 50 mm (preferably 10 mm to 30 mm) in the present embodiments, 1000 mm≥L>500 mm in the example in the related art in (a) of FIG. 3, whereas in the present application, 500 mm≥L≥0 mm, preferably 300 mm≥L≥0 mm, and most preferably L=0 mm, that is, the transfer member 20 does not exist in any of the embodiments of (b) of FIG. 3, (a) of FIG. 4, and (b) of FIG. 4.

The lower endless conveyor 32 bent by the folding-back unit 42 is bridged over the folding-back assisting unit 44. Since the folding-back assisting unit 44 is disposed farther from the terminal end of the continuous coagulation machine 10 than the folding-back unit 42 and disposed below the folding-back unit 42, an acute angle θ (correlated with −90°<θ<90°≈90°<α<270° to be described later) can be maintained at a bent portion of the lower endless conveyor 32 at the folding-back unit 42.

In FIG. 3 and FIG. 4, dimensions A1 (the example in the related art), A2, A3, and A4 each indicate a difference A in height between the conveyance surface of the conveyor 13 of the continuous coagulation machine 10 and the conveyance surface of the lower endless conveyor 32 of the continuous forming machine 30. Dimensions B1, B2, B3, and B4 each indicate a center axis distance B between the rotation center axis of the drive roller 12 at the terminal end of the continuous coagulation machine 10 and a center axis of the folding-back unit 42 at the starting end of the continuous forming machine 30. Dimensions C1, C2, C3, and C4 each indicate a distance between the drive roller 12 and the folding-back unit 42, and more specifically, a relative horizontal distance C (substantially the same as a distance L in a horizontal direction, in other words, a conveying direction of the sheet-shaped tofu T) between a rearmost end of the drive roller 12 and a foremost end of the folding-back unit 42. Angles β1, β2, β3, and β4 each indicate an inclination angle β of the transfer member 20 with respect to the conveyance surface of the conveyor 13.

In the above examples, A1 (the example in the related art)>A2>A3>0 and A4=0 are satisfied, and the conveyance surface of the conveyor 13 of the continuous coagulation machine 10 is located above the conveyance surface of the lower endless conveyor 32 of the continuous forming machine 30. The difference A in height between the two conveyance surfaces is A1≥A2≥A3≥A4=0, and the difference A in height in each of the embodiments is smaller than that in the related art. The dimension A is preferably small, and most preferably there is no difference in height. When the diameter of the drive roller 12 is 500 mm to 1000 mm, and the diameter (the thickness) of the folding-back unit 42 is 51 mm or more to 200 mm in the example in the related art and is 5 mm to 50 mm (preferably 10 mm to 30 mm) in the present embodiments, 300 mm≥A1>200 mm in the example in the related art in (a) of FIG. 3, whereas in the present embodiments, 200 mm≥A2>100 mm in the embodiment of (b) of FIG. 3, preferably 100 mm≥A3>0 mm in the embodiment of (a) of FIG. 4, and most preferably A4=0 mm in the embodiment of (b) of FIG. 4.

In the above examples, B1 (the example in the related art)>B2>B3>B4>0 is satisfied, and the rotation center axis of the drive roller 12 at the terminal end of the continuous coagulation machine 10 and the center axis of the folding-back unit 42 at the starting end of the continuous forming machine 30 are separated from each other by a predetermined distance in the horizontal direction. The center axis distance B is B1>B2>B3>B4, and the center axis distance B in each of the embodiments is smaller than that in the related art. The dimension B is also related to the length of the transfer member 20, but in order to shorten the sliding distance of the tofu and a machine length, the dimension B is preferably small, and ideally and most preferably zero. When the diameter of the drive roller 12 is 500 mm to 1000 mm, and the diameter (the thickness) of the folding-back unit 42 is 51 mm or more to 200 mm in the example in the related art and is 5 mm to 50 mm (preferably 10 mm to 30 mm) in the present embodiments, 2000 mm≥B1>1000 mm in the example in the related art in (a) of FIG. 3, whereas in the present embodiments, 1000 mm≥B2, B3, B4>0 mm, preferably 500 mm≥B3, B4>0 mm in the embodiments of (b) of FIG. 3, (a) of FIG. 4, and (b) of FIG. 4, and most preferably B=0 mm although not illustrated (that is, L=0 mm).

In the above examples, C1 (the example in the related art)>C2>0 and 0≥C3>C4 are satisfied. The dimensions C1, C2, C3, and C4 each indicate the relative horizontal distance between the rearmost end of the drive roller 12 and the foremost end of the folding-back unit 42, and C1>C2>0, that is, positive C1 and C2 mean that the rearmost end of the drive roller 12 and the foremost end of the folding-back unit 42 are separated from each other in the horizontal direction (the conveying direction of the sheet-shaped tofu T) by a predetermined distance. However, C2 is extremely small, and C2≈0. Further, the rearmost end of the drive roller 12 and the foremost end of the folding-back unit 42 may be in contact with each other, that is, located at the same position in the horizontal direction, and in this case, C2 is zero (C2=0). On the other hand, 0>C3>C4, that is, negative C3 and C4 mean that the rearmost end of the drive roller 12 and the foremost end of the folding-back unit 42 overlap each other in the horizontal direction (the conveying direction of the sheet-shaped tofu T). When viewed from above, for C2, C3, or C4, a form is used in which the foremost end of the folding-back unit 42 is extremely close to the rearmost end of the drive roller 12 or overlaps with and covers the rearmost end of the drive roller 12. Of course, even when the two rollers overlap with each other in the horizontal direction, as shown in (a) of FIG. 4 and (b) of FIG. 4, the two rollers do not collide with each other since the diameter of the folding-back unit 42 is smaller than the diameter of the drive roller 12. It is preferable that the dimension C has a larger negative value of zero or less (an overlapping state when viewed from above) since the machine length is shortened. For example, when the diameter of the drive roller 12 is 500 mm to 1000 mm, and the diameter (the thickness) of the folding-back member is 51 mm or more to 200 mm in the example in the related art and is 5 mm to 50 mm (preferably 10 mm to 30 mm) in the present embodiments, 500 mm≥C1>300 mm in the example in the related art in (a) of FIG. 3, whereas 300 mm≥C2>0 mm in the embodiment of (b) of FIG. 3, preferably 0 mm≥C3>−300 mm in the embodiment of (a) of FIG. 4, and most preferably −300 mm≥C4>−500 mm in the embodiment of (b) of FIG. 4.

That is, it is preferable that in order to shorten the machine length, a center of the rotating roller or the fixing member constituting the folding-back unit 42 is located between a center of the drive roller 12 and the conveyance surface of the conveyor 13 in the up-and-down direction, and disposed at a position where the center of the rotating roller or the fixing member overlaps with the drive roller 12 when viewed from above. It is more preferable that a profile of a cross-sectional shape of the rotating roller or the fixing member is disposed between the center of the drive roller 12 and the conveyance surface of the conveyor 13 in the up-and-down direction, between the center of the drive roller 12 and the rearmost end of the drive roller 12 in the horizontal direction, and in a region where the rotating roller or the fixing member does not interfere with the drive roller 12.

Further, in the above examples, β1 (the example in the related art)>β2>β3>0 and β4=0 are satisfied, and the transfer member 20 is inclined upward with respect to the conveyance surface of the conveyor 13 when viewed from a continuous forming machine 30 side. The inclination angle β is β1>β2>β3>β4=0, and the inclination angle β in each of the embodiments is smaller than that in the related art. When the angle of the transfer member 20 is small, it is possible to avoid a trouble such as breaking down or clogging due to slipperiness of the tofu, and thus β is preferably small and β=0° is most preferable. For example, when the diameter of the drive roller 12 is 500 mm to 1000 mm, and the diameter (the thickness) of the folding-back member is 51 mm or more to 200 mm in the example in the related art and is 5 mm to 50 mm (preferably 10 mm to 30 mm) in the present embodiments, 45°≥β1>30° in the example in the related art in (a) of FIG. 3, whereas 30°≥β2>10° in the embodiment of (b) of FIG. 3, preferably 10°≥β3>0° in the embodiment of (a) of FIG. 4, and most preferably β4=0° in the embodiment of (b) of FIG. 4.

As described above, in each of the embodiments, values of the difference A in height, the center axis distance B, the relative horizontal distance C, and the inclination angle β are smaller than those in the device in the related art. The result means that according to the present invention, a distance between the continuous coagulation machine 10 and the continuous forming machine 30 can be shortened and the length of the transfer member 20 in the conveying direction can also be shortened. The result means that a difference in height between the continuous coagulation machine 10 and the continuous forming machine 30 can be reduced and inclination of the transfer member 20 can also be reduced. Therefore, it is possible to reduce a length and a height of the entire tofu continuous production device 1 and achieve space saving. By reducing the length of the transfer member 20 in the conveying direction and the inclination angle of the transfer member 20, the tofu can also be smoothly transferred, and a trouble such as breakage of the tofu can also be prevented.

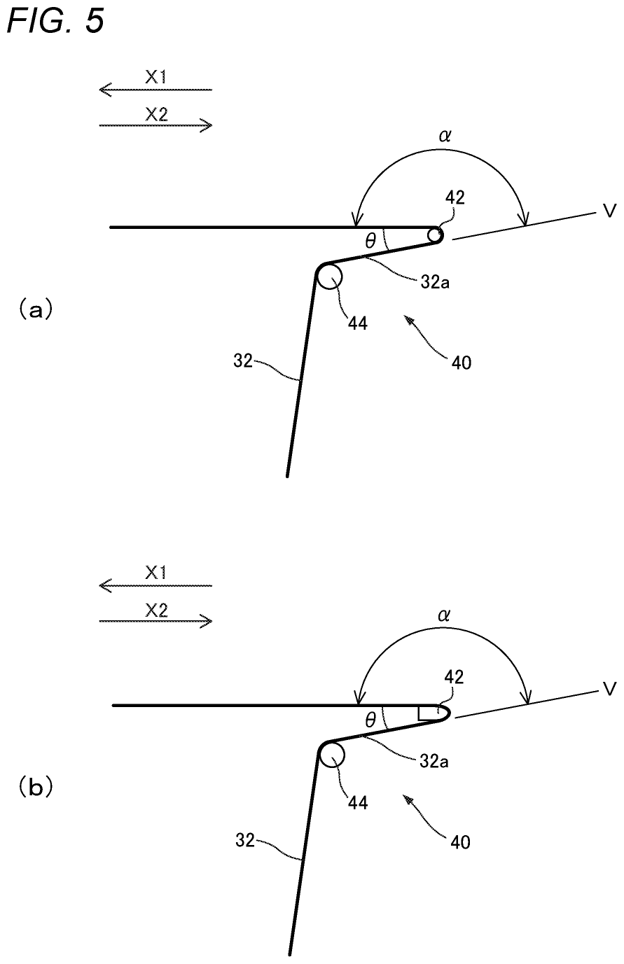

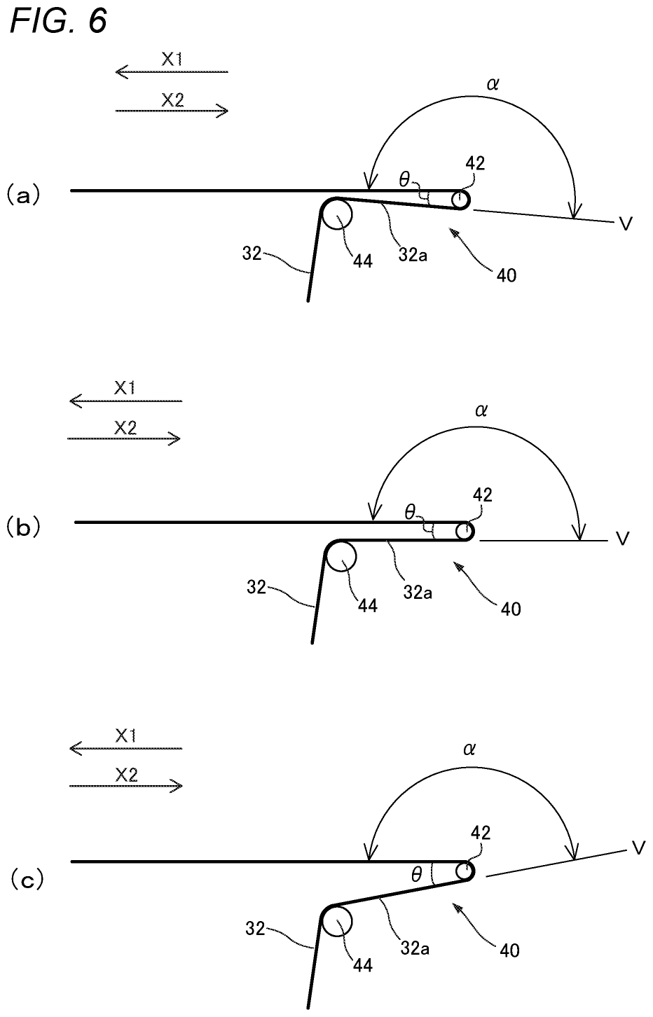

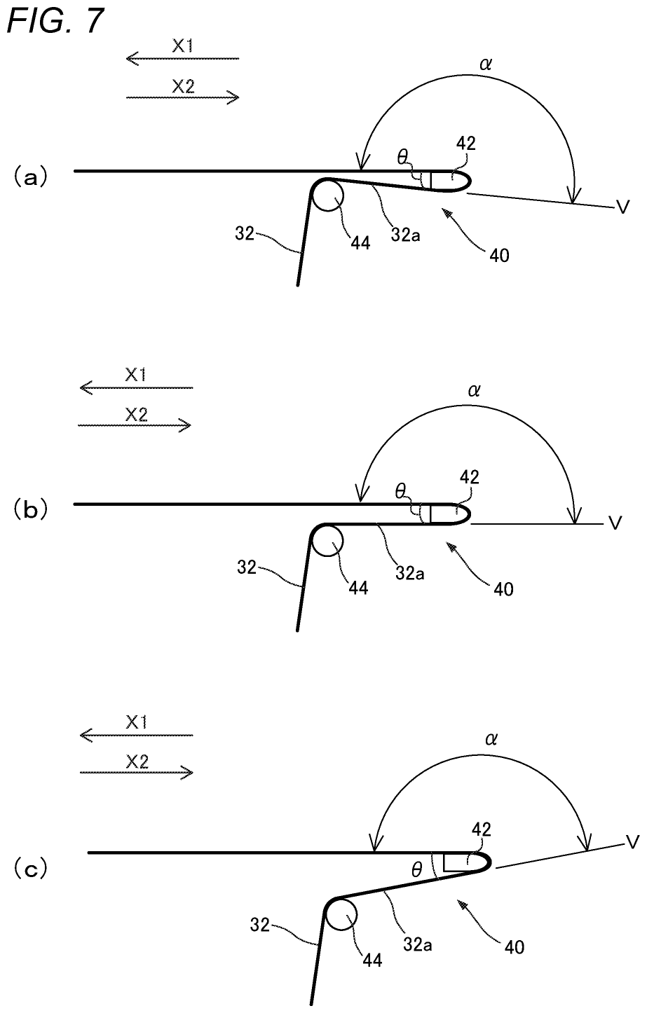

FIGS. 5 to 7 show various embodiments of the folding-back guide unit 40. The conveying direction of the tofu may be either from right to left (a direction of the arrow X1) or from the left to the right (a direction of the arrow X2) in the drawing sheet. In the lower endless conveyor 32, a folding-back surface 32a from the folding-back unit 42 toward the folding-back assisting unit 44 is defined, and a virtual plane V is defined which is obtained by rotating the folding-back surface 32a by 180 degrees about the folding-back unit 42. In the present embodiment, an angle α formed by the conveyance surface of the lower endless conveyor 32 of the continuous forming machine and the virtual plane V is set within a range of 90°<α<270°. The angle α in each drawing schematically shows a center of the folding-back unit 42 as an intersection point between the conveyance surface and the virtual plane V.

A range of the angle α is preferably set to 120°≤α≤240°, more preferably set to 135°≤α≤225°, and most preferably set to 150°≤α≤180°. By such setting, as illustrated, when viewed from a lateral direction of the device, the lower endless conveyor 32 rotates in a state where the lower endless conveyor 32 is folded back, at the folding-back unit 42, at the acute angle like a knife edge shape. With such a configuration, the drive roller 12 and the folding-back unit 42 can be brought close to each other, space saving for the tofu continuous production device 1 can be achieved, the transfer member 20 can also be reduced in size, and the trouble such as the breakage of the tofu can be prevented.

(a) of FIG. 5 shows an embodiment in which the folding-back unit 42 is implemented by the small-diameter rotating roller. The rotating roller is a so-called freely rotating roller that idles about a rotation axis, includes a bearing such as a bearing part or a resin collar, and is driven by another drive roller. (b) of FIG. 5 shows an embodiment in which the folding-back unit 42 is implemented by a fixed shaft which is the thin fixing member. The fixing member is fixed and disposed at a predetermined position, and does not rotate. As the fixing member, a flat plate or the like having a round shape on one side is disposed. The rotating roller or the fixing member may be provided, at an appropriate position such as both ends or a center thereof, with a support member that supports the rotating roller or the fixing member from a base (not illustrated), and the rotating roller or the fixing member is a member that has a strength capable of withstanding deflection due to tension of a belt constituting the lower endless conveyor 32 (in particular, large tensile tension that acts in a state where the tofu is placed or under a press load) and that has a smooth rotation surface or a smooth surface to cause the belt to easily slide thereon.

FIG. 6 shows embodiments in which the folding-back unit 42 is implemented by the small-diameter rotating roller as in (a) of FIG. 5. (a) of FIG. 6 shows the embodiment in which the angle α is 180°<α≤225°, (b) of FIG. 6 shows the embodiment in which the angle α is α=180°, and (c) of FIG. 6 shows the embodiment in which the angle α is 150°≤α<180°.

FIG. 7 shows embodiments in which the folding-back unit 42 is implemented by the fixed shaft which is the thin fixing member, as in (b) of FIG. 5. (a) of FIG. 7 shows the embodiment in which the angle α is 180°<α≤225°, (b) of FIG. 7 shows the embodiment in which the angle α is α=180°, and (c) of FIG. 7 shows the embodiment in which the angle α is 150°≤α<180°.

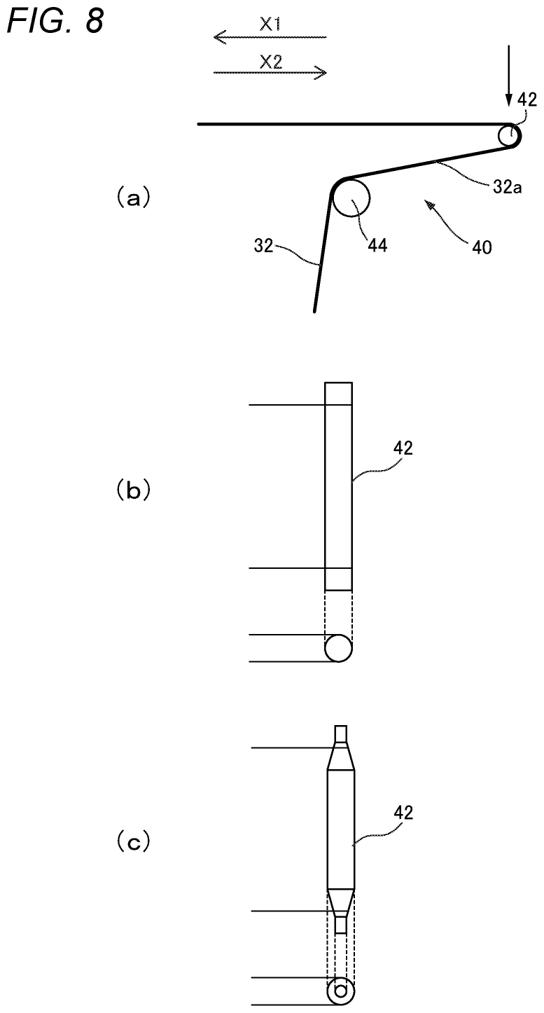

FIG. 8 shows embodiments in which the folding-back unit 42 is implemented by the small-diameter rotating roller as in (a) of FIG. 5. (a) of FIG. 8 shows a view equivalent to (a) of FIG. 5, (b) of FIG. 8 is a plan view when viewed from an arrow direction in (a) of FIG. 8 and shows a form of the rotating roller having a simple bar shape, and (c) of FIG. 8 is a plan view when viewed from the arrow direction in (a) of FIG. 8 and shows a form of the rotating roller having a bar shape in which both ends are each narrowed in a tapered shape. Since the both ends are each formed in the tapered shape, tension applied to the both ends of the folding-back unit 42 can be relaxed, and an effect of preventing meandering and wrinkling of the belt of the conveyor is also expected.

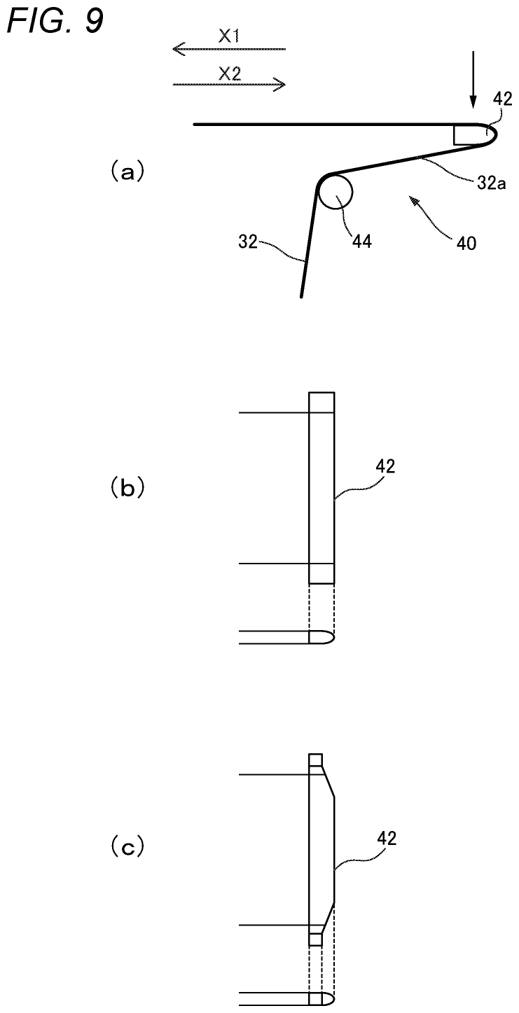

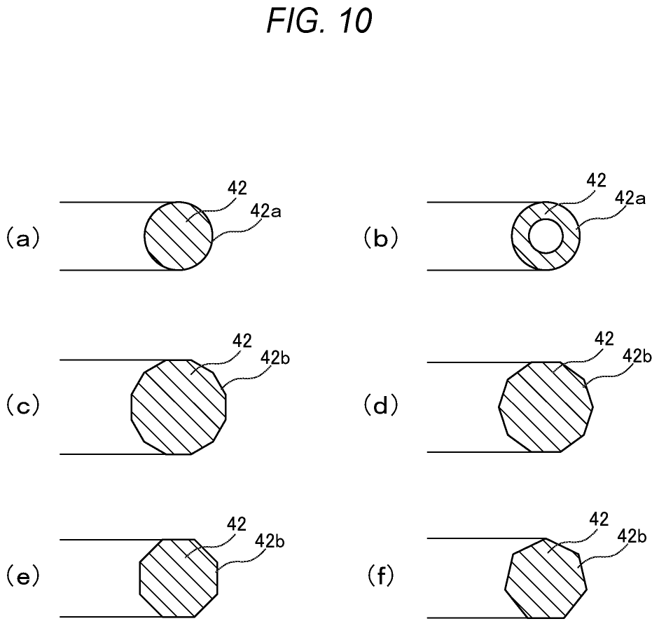

FIG. 9 shows embodiments in which the folding-back unit 42 is implemented by the fixed shaft which is the thin fixing member, as in (b) of FIG. 5. (a) of FIG. 9 shows a view equivalent to (b) of FIG. 5, (b) of FIG. 9 is a plan view when viewed from an arrow direction in (a) of FIG. 9 and shows a form of the fixing member having a simple bar shape, and (c) of FIG. 9 is a plan view when viewed from the arrow direction in (a) of FIG. 9 and shows a form of the fixing member having a bar shape in which both ends are each narrowed in a tapered shape. Since the both ends are each formed in the tapered shape, tension applied to the both ends of the folding-back unit 42 can be relaxed, and an effect of preventing meandering and wrinkling of the belt of the conveyor is also expected.

FIG. 10 shows various embodiments of a cross-sectional shape of the folding-back unit 42 implemented by the rotating roller, (a) of FIG. 10 shows a cross-sectional shape of a circular cross section, (b) of FIG. 10 shows a cross-sectional shape of a cylindrical cross section, (c) of FIG. 10 shows a cross-sectional shape of a polygonal (dodecahedral) cross section, (d) of FIG. 10 shows a cross-sectional shape of a polygonal (decahedral) cross section, (e) of FIG. 10 shows a cross-sectional shape of a polygonal (octahedral) cross section, and (f) of FIG. 10 shows a cross-sectional shape of a polygonal (heptahedral) cross section. A form in each of (a) of FIG. 10 and (b) of FIG. 10 exhibits a circular cross section and includes a curved surface 42a including at least a circular arc, and a form in each of (c) to (f) of FIG. 10 exhibits a polygonal cross section and includes a polyhedral surface 42b. Friction is generated on the belt of the conveyor due to contact with the folding-back unit 42, but the belt of the conveyor is smoothly conveyed by an action of the curved surface 42a or the polyhedral surface 42b. The cross-sectional shape is preferably a polyhedron having six or more faces.

The rotating roller constituting the folding-back unit 42 is a small-diameter round bar, a hollow pipe having a diameter of, for example, 5 mm to 50 mm, a square bar having a polygonal cross section having six or more sides, or the like. The rotating roller may be an idler roller or a drive roller driven by a drive motor.

FIG. 11 shows various embodiments of a cross-sectional shape of the folding-back unit 42 implemented by the fixing member, (a) of FIG. 11 shows a circular cross section, (b) of FIG. 11 shows a cylindrical cross section, (c) of FIG. 11 shows an elliptical cross section, (d) of FIG. 11 shows a bullet-shaped cross section, (e) of FIG. 11 shows a substantially rectangular cross section, (f) of FIG. 11 shows a substantially rectangular cross section, (g) of FIG. 11 shows a dome-shaped cross section, (h) of FIG. 11 shows a sector-shaped cross section, (i) of FIG. 11 shows a polygonal (dodecahedral) cross section, (j) of FIG. 11 shows a polygonal (decahedral) cross section, (k) of FIG. 11 shows a polygonal (octahedral) cross section, (l) of FIG. 11 shows a polygonal (heptahedral) cross section, and (m) of FIG. 11 shows a U-shaped cross section. A form in each of (a) to (h) of FIG. 11 and (m) of FIG. 11 exhibits a circular cross section and includes the curved surface 42a including at least a circular arc, and a form in each of (i) to (l) of FIG. 11 exhibits a polygonal cross section and includes the polyhedral surface 42b. Friction is generated on the belt of the conveyor due to contact with the folding-back unit 42, but the belt of the conveyor is smoothly conveyed by the action of the curved surface 42a or the polyhedral surface 42b. When the cross-sectional shape is polygonal, the cross-sectional shape is preferably a polygonal shape having six or more sides.

It is preferable that the curved surface 42a or the polyhedral surface 42b is subjected to various surface treatments by mirror polishing, ceramic thermal spraying, or the like to reduce a sliding resistance with the belt constituting the conveyor as much as possible, and is subjected to hard-facing by hardening treatment. The fixing member constituting the folding-back unit 42 may be implemented by a small-diameter round bar, a hollow pipe, a square bar having a polygonal cross section having six or more sides, or the like, which has a diameter or a thickness in a vertical direction of, for example, 5 mm to (less than) 50 mm. The surface treatments (surface modification, coating, and the like) are to improve a sliding property or smoothness and to improve wear resistance, and examples of the modification for a material surface include shot peening, nitridation treatment, and the like. Examples of the coating include, but are not limited to, titanium nitride-based coating, titanium carbonitride-based coating, diamond-like carbon (DLC) coating, chromium nitride-based coating, titanium-aluminum-nitride-based coating, chromium carbide-based coating, ceramic thermal spraying, or a laminated film in which these coatings are combined.

In the above embodiments, the tofu transfer mechanism 50 transfers the sheet-shaped tofu T from the continuous coagulation machine 10 to the continuous forming machine 30. However, the tofu transfer mechanism 50 can transfer the sheet-shaped tofu T not only between the continuous coagulation machine 10 and the continuous forming machine 30 but also between other two production devices. For example, the tofu transfer mechanism 50 can transfer the sheet-shaped tofu T from the continuous coagulation machine 10 or the continuous forming machine 30 to a conveying device for a next process. The conveying device for a next process includes, for example, a cutting machine, a fryer, a freezer, and a packaging machine, and is not particularly limited. A wire net belt made of metal is generally used in a conveyor included in the fryer or the freezer. For example, the tofu transfer mechanism 50 can transfer the sheet-shaped tofu T to a tuning conveyor for the cutting machine that rotates in the same direction as the continuous forming machine 30. In addition, the tofu transfer mechanism 50 can transfer the block-shaped tofu (or the cake of tofu) to an endless transfer conveyor that rotates in a direction intersecting with (crossing or orthogonal to) the continuous coagulation machine 10 or the continuous forming machine 30, and the block-shaped tofu (or the cake of tofu) is obtained by cutting the sheet-shaped tofu T into a block shape or a strip shape.

That is, in the tofu continuous production device 1, the tofu transfer mechanism 50 can transfer the sheet-shaped tofu from a first production device to a second production device. The first production device and the second production device are various devices used for producing the tofu, and types thereof are not particularly limited.

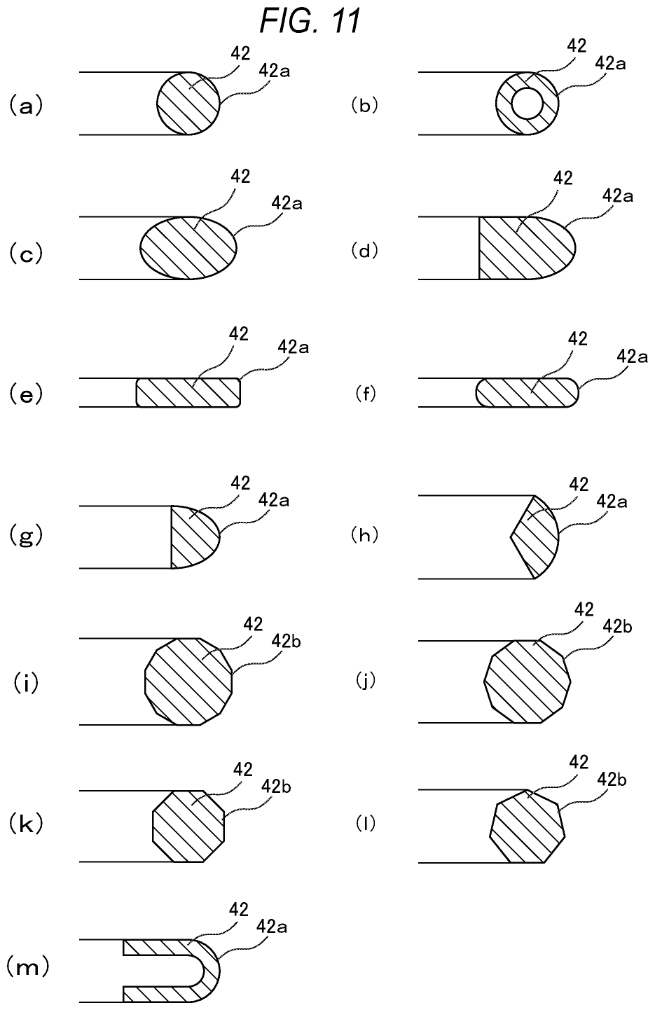

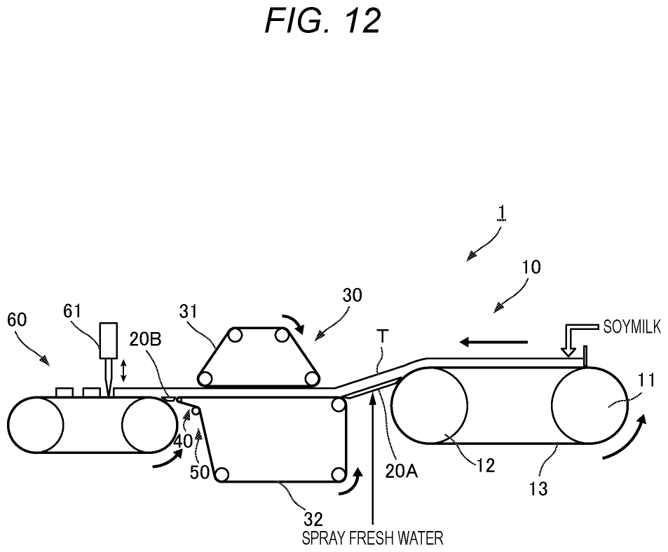

FIG. 12 shows a tofu continuous production device 1 according to another embodiment, and the tofu continuous production device 1 includes the continuous coagulation machine 10, the continuous forming machine 30, a cutting machine 60, and the tofu transfer mechanism 50. Between the continuous coagulation machine 10 and the continuous forming machine 30, the sheet-shaped tofu T is transferred by a plate-shaped transfer member 20A in the related art. On the other hand, between the continuous forming machine 30 and the cutting machine 60, the sheet-shaped tofu T is transferred by the tofu transfer mechanism 50 including a transfer member 20B. The sheet-shaped tofu T transferred to the cutting machine 60 is cut into the block-shaped tofu by a cutting device 61 having a cutting blade.

That is, in the embodiment shown in FIG. 12, the first production device corresponds to the continuous forming machine 30, and the second production device corresponds to the cutting machine 60. The folding-back guide unit 40 is provided at a terminal end of the continuous forming machine 30 which is the first production device.

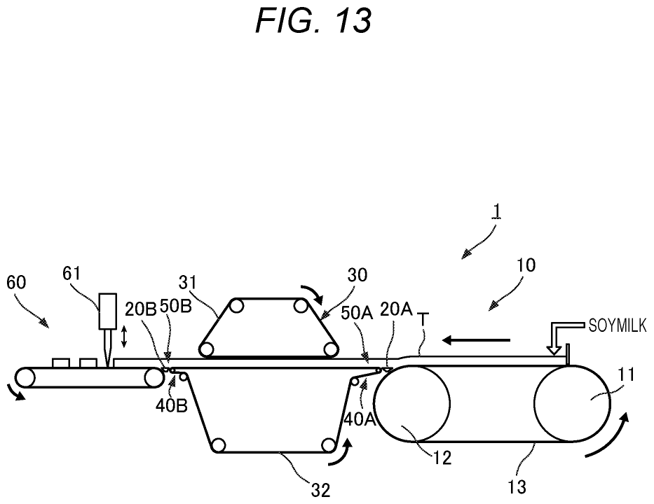

FIG. 13 shows a tofu continuous production device 1 according to another embodiment, and the tofu continuous production device 1 includes the continuous coagulation machine 10, the continuous forming machine 30, the cutting machine 60, a first tofu transfer mechanism 50A, and a second tofu transfer mechanism 50B. That is, between the continuous coagulation machine 10 and the continuous forming machine 30, the sheet-shaped tofu T is transferred by the first tofu transfer mechanism 50A that includes the transfer member 20A and a folding-back guide unit 40A. On the other hand, between the continuous forming machine 30 and the cutting machine 60, the sheet-shaped tofu T is transferred by the second tofu transfer mechanism 50B that includes the transfer member 20B and a folding-back guide unit 40B.

That is, in the embodiment shown in FIG. 13, the first production device corresponds to the continuous coagulation machine 10, the second production device corresponds to the continuous forming machine 30, and a third production device corresponds to the cutting machine 60. The folding-back guide unit 40A and the folding-back guide unit (the other folding-back guide unit) 40B are respectively provided at the starting end and the terminal end of the continuous forming machine 30 which is the second production device.

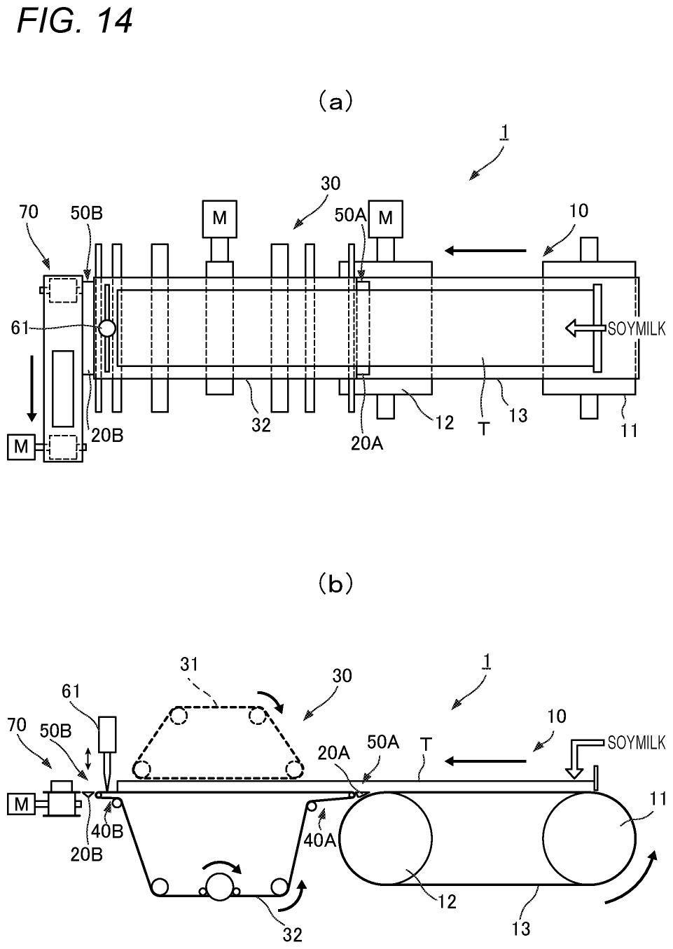

FIG. 14 shows a tofu continuous production device 1 according to another embodiment, and the tofu continuous production device 1 includes the continuous coagulation machine 10, the continuous forming machine 30, a conveying machine 70, the first tofu transfer mechanism 50A, and the second tofu transfer mechanism 50B. That is, between the continuous coagulation machine 10 and the continuous forming machine 30, the sheet-shaped tofu T is transferred by the first tofu transfer mechanism 50A that includes the transfer member 20A and the folding-back guide unit 40A. On the other hand, between the continuous forming machine 30 and the conveying machine 70, the sheet-shaped tofu T is transferred by the second tofu transfer mechanism 50B that includes the transfer member 20B and the folding-back guide unit 40B. The cutting device 61 is provided at the terminal end of the continuous forming machine 30, and the block-shaped tofu cut out by the cutting device 61 is sent to a next process by the conveying machine 70. The conveying machine 70 conveys the block-shaped tofu in a direction orthogonal to the conveying direction of the continuous coagulation machine 10 and the continuous forming machine 30. The device may be a form in which the transfer member 20B does not exist (L=0) and the terminal end of the continuous forming machine 30 is disposed to slightly overlap with the conveying machine 70 when viewed from directly above so as to cover the conveying machine 70.

That is, in the embodiment shown in FIG. 14, the first production device corresponds to the continuous coagulation machine 10, the second production device corresponds to the continuous forming machine 30, and the third production device corresponds to the conveying machine 70. The folding-back guide unit 40A and the folding-back guide unit (the other folding-back guide unit) 40B are respectively provided at the starting end and the terminal end of the continuous forming machine 30 which is the second production device.

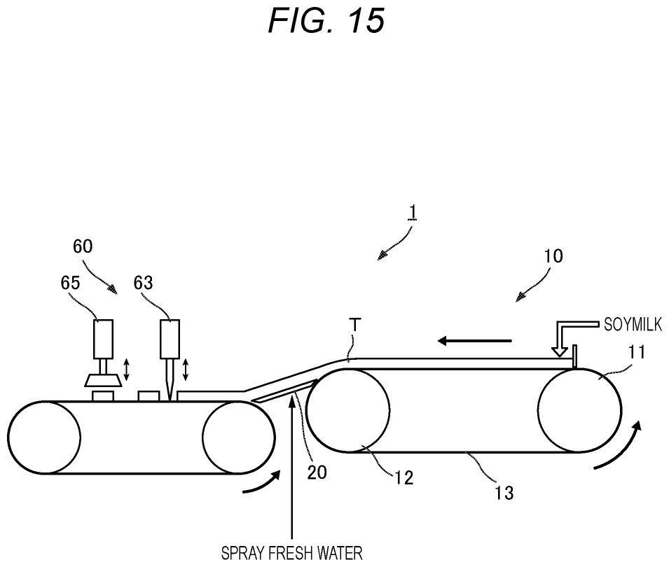

FIG. 15 shows a tofu continuous production device 1 in the related art. The tofu continuous production device 1 includes the continuous coagulation machine 10, the cutting machine 60, and the tofu transfer mechanism 50, and between the continuous coagulation machine 10 and the cutting machine 60, the sheet-shaped tofu T is transferred by the plate-shaped transfer member 20 in the related art. The cutting machine 60 includes: a first cutting device 63 that cuts the sheet-shaped tofu T in the lateral direction (a direction perpendicular to the conveying direction and perpendicular to the drawing sheet); and a second cutting device 65 that cuts the sheet-shaped tofu T in a longitudinal direction (a direction along the conveying direction and along the drawing sheet). By these devices, the sheet-shaped tofu T is cut into the block-shaped tofu and transferred to a packing device (not illustrated)

Each of (a) to (c) of FIG. 16 shows the continuous coagulation machine 10 and the cutting machine 60 in a tofu continuous production device 1 according to another embodiment of the present invention. The continuous coagulation machine 10 is for silken tofu or a curd for frozen silken tofu and serves as the first production device, and the cutting machine 60 serves as the second production device. In the tofu continuous production device 1 shown in (a) of FIG. 16, the tofu transfer mechanism 50 including the folding-back guide unit 40 is provided on a downstream side of the transfer member 20 in FIG. 15. In the tofu continuous production device 1 shown in (b) of FIG. 16, the first cutting device 63 in (a) of FIG. 16 is provided on the continuous coagulation machine 10, and only the second cutting device 65 is provided in the cutting machine 60. The second cutting device 65 also has a function of cutting the sheet-shaped tofu T in the longitudinal direction and increasing an interval in the lateral direction.

In a form in (b) of FIG. 16, the first cutting device 63 is provided at the terminal end of the continuous coagulation machine 10 and the tofu can be cut in a state where there are side walls, and thus a shape can be accurately cut into a strip-shaped rectangular parallelepiped. When the sheet-shaped tofu T is transferred onto a conveyor of the cutting machine, the tofu sags due to softness of the tofu, and thus the tofu is difficult to be cut accurately and many extra parts exist on both ends. However, in the form, the tofu can be cut accurately without sagging at positions where side walls are located, and the extra parts can also be minimized.

The tofu continuous production device 1 in (c) of FIG. 16 includes the continuous coagulation machine 10, a distribution and alignment machine 80, and the tofu transfer mechanism 50. The continuous coagulation machine 10 is provided with the first cutting device 63, and a roll cutter 67 that cuts the sheet-shaped tofu T in the longitudinal direction similarly to the second cutting device 65. However, the roll cutter 67 does not have a function of increasing an interval in the lateral direction like the second cutting device 65. The block-shaped tofu, which is obtained by cutting laterally elongated strip-shaped tofu into a block shape (for example, a cake) in the continuous coagulation machine 10, is sent to the distribution and alignment machine 80 by the tofu transfer mechanism 50. The adjacent tofu blocks are arranged in a staggered shape by a tofu conveyor below the distribution and alignment machine 80, and a distribution and alignment device 81 including a staggered distribution member in which a comb-shaped stopper member moves up and down. In the staggered shape, an interval in the front-and-rear direction is increased. The distribution and alignment device 81 may include, for example, a suction device that suctions and lifts the block-shaped tofu, or may lift and move the block-shaped tofu.

That is, in the embodiments shown in (a) to (c) of FIG. 16, the first production device corresponds to the continuous coagulation machine 10, and the second production device corresponds to the cutting machine 60 or the distribution and alignment machine 80. Further, the folding-back guide unit 40 is provided at a starting end of the cutting machine 60 or the distribution and alignment machine 80 which is the second production device.

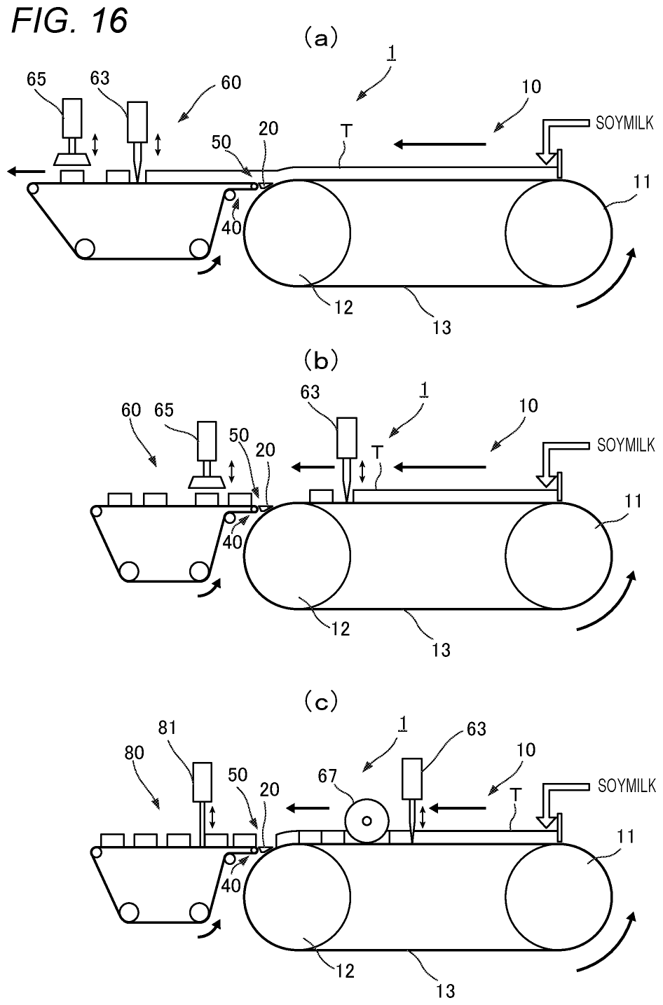

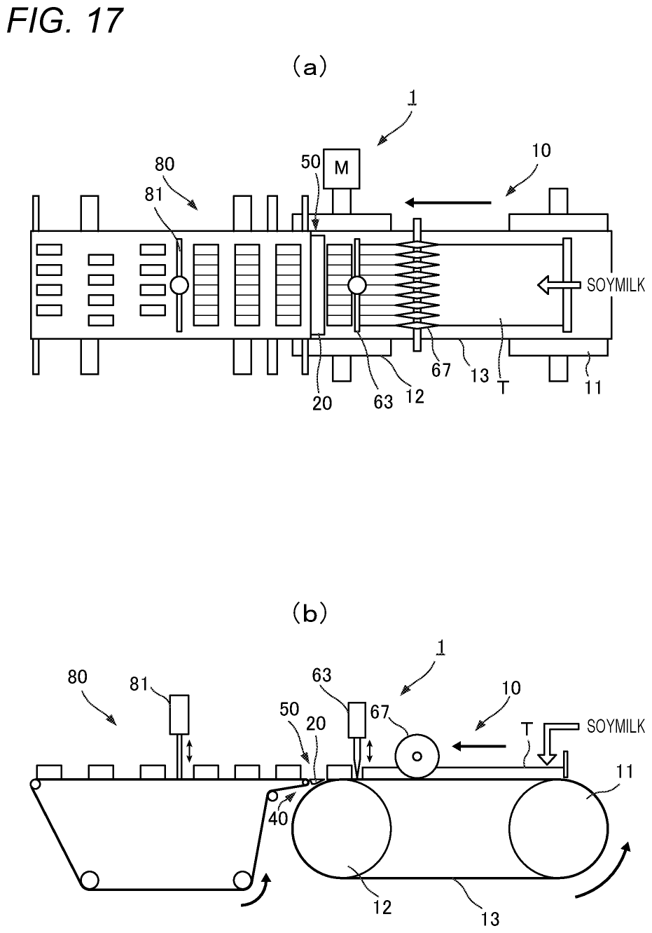

FIG. 17 shows a tofu continuous production device 1 according to another embodiment, and the tofu continuous production device 1 includes the continuous coagulation machine 10, the distribution and alignment machine 80, and the tofu transfer mechanism 50. In the present embodiment, in the continuous coagulation machine 10, the roll cutter 67 first cuts the sheet-shaped tofu T in the longitudinal direction, and then the first cutting device 63 cuts the sheet-shaped tofu T in the lateral direction. The block-shaped tofu, which is obtained by cutting longitudinally strip-shaped tofu into a block shape (for example, a cake) in the continuous coagulation machine 10, is sent to the distribution and alignment machine 80 by the tofu transfer mechanism 50. The adjacent tofu blocks are arranged in a staggered shape by the tofu conveyor below the distribution and alignment machine 80, and the distribution and alignment device 81 including the staggered distribution member in which the comb-shaped stopper member moves up and down. In the staggered shape, an interval in the front-and-rear direction is increased.

That is, in the embodiment shown in FIG. 17, the first production device corresponds to the continuous coagulation machine 10, and the second production device corresponds to the distribution and alignment machine 80. Further, the folding-back guide unit 40 is provided at the starting end of the distribution and alignment machine 80 which is the second production device.

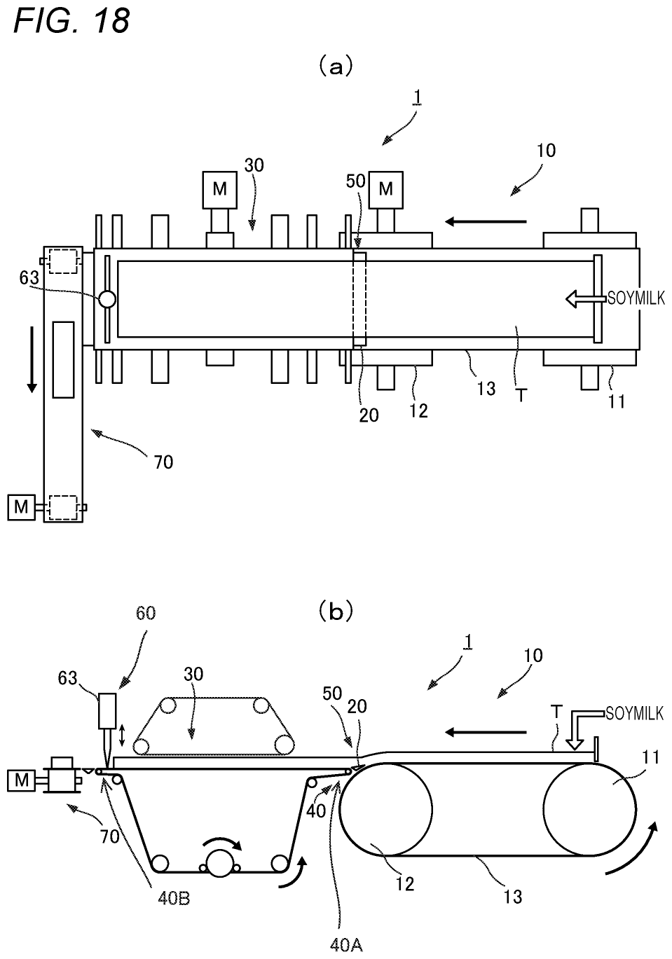

FIG. 18 shows a tofu continuous production device 1 according to another embodiment, and the tofu continuous production device 1 includes the continuous coagulation machine 10, the continuous forming machine 30, the conveying machine 70, the tofu transfer mechanism 50, and the cutting machine 60. In the present embodiment, at the terminal end of the continuous forming machine 30, the first cutting device 63 cuts the sheet-shaped tofu T in the lateral direction. The conveying machine 70 conveys, in a direction, the strip-shaped tofu cut only in the lateral direction, and sends the strip-shaped tofu to a next process, and the direction intersects at a right angle with the conveying direction of the continuous forming machine 30.

That is, in the embodiment shown in FIG. 18, the first production device corresponds to the continuous coagulation machine 10, the second production device corresponds to the continuous forming machine 30, and the third production device corresponds to the cutting machine 60 that laterally performs cutting. The folding-back guide unit 40A and the folding-back guide unit (the other folding-back guide unit) 40B are respectively provided at the starting end and the terminal end of the continuous forming machine 30 which is the second production device.

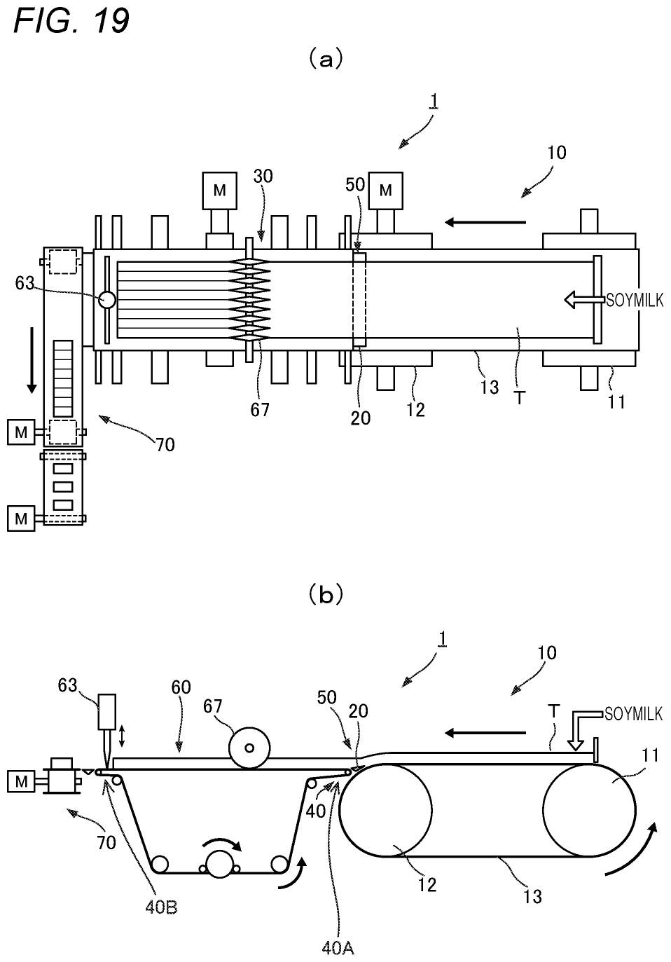

FIG. 19 shows a tofu continuous production device 1 according to another embodiment, and the tofu continuous production device 1 includes the continuous coagulation machine 10, the continuous cutting machine 60, the conveying machine 70, and the tofu transfer mechanism 50. In the present embodiment, in the continuous cutting machine 60, the roll cutter 67 first cuts the sheet-shaped tofu T in the longitudinal direction, and then the first cutting device 63 cuts the sheet-shaped tofu T in the lateral direction. The conveying machine 70 conveys, for example, a cake or several cakes of the cut block-shaped tofu, and sends the block-shaped tofu to a next process.

That is, in the embodiment shown in FIG. 19, the first production device corresponds to the continuous coagulation machine 10, the second production device corresponds to the continuous cutting machine 60, and the third production device corresponds to the conveying machine 70. The folding-back guide unit 40A and the folding-back guide unit (the other folding-back guide unit) 40B are respectively provided at a starting end and a terminal end of the continuous cutting machine 60 which is the second production device.

The conveyor included in the continuous forming machine 30 which is the first or second production device shown in FIGS. 12 to 14, 18, and 19 may be other than a metal belt, a food belt, a Teflon belt, a wire net belt, or the like in which the diameter (the thickness) of the folding-back unit is large (thick) and is 50 mm or more. That is, the conveyor included in the continuous forming machine 30 is preferably the resin filter fabric belt, the food belt, or the Teflon belt that forms the knife-edge-shaped folding-back unit whose diameter (thickness) is small (thin) and is 5 mm or more and less than 50 mm, and preferably 5 mm to 30 mm. Other forms may be a wire net conveyor (the glasses link belt conveyor, the flat flex conveyor, the chocolate conveyor, or the like) that includes the wire net belt, and the like, and the wire net belt is made of a wire net or a wire mesh made of stainless steel or the like. Therefore, the conveyor included in the continuous forming machine 30 is not particularly limited as long as the material or form is the flexible and tough material capable of forming a knife-edge-shaped fold.

An endless conveyor included in the cutting machine 60, the conveying machine 70, or the distribution and alignment machine 80 which is the second or third production device shown in FIGS. 12 to 14, 18, and 19 is preferably a food belt, a Teflon belt, or a metal belt, which includes a shaft that has a diameter of 50 mm or more and that has a relatively large diameter at a front end. The food belt or the Teflon belt has a diameter of 50 mm to 300 mm, and the metal belt has a diameter of 300 mmφ to 1500 mmφ and preferably has a diameter of 500 mmφ to 1000 mmφ. Other forms of the endless conveyor may be a resin filter fabric belt and a wire net conveyor (a glasses link belt conveyor, a flat flex conveyor, a chocolate conveyor, or the like) including a wire net belt, the wire net belt is made of a wire or a wire mesh made of stainless steel or the like, and the food belt in a broad sense may be a roller conveyor, a top chain conveyor made of a metal such as stainless steel or a resin, a slat band chain conveyor, a plastic modular chain conveyor, a plastic top chain conveyor made of a resin, or the like. That is, the endless conveyor included in the cutting machine 60, the conveying machine 70, or the distribution and alignment machine 80 is not particularly limited as long as a material thereof is a belt material that forms the folding-back unit having the diameter (the thickness) of 50 mm or more. Further, the conveyor of the second or third production device may convey the tofu in a direction intersecting with the tofu conveying direction of the first or second production device, and a material of the conveyor of the second or third production device in this case is not particularly limited.

Although not illustrated, the first production device and the second production device may be interchanged (similarly to FIGS. 1 and 2, the conveyor may be a food belt including a shaft having a relatively large diameter at a rear end of the first production device, and the second production device may use a flexible material to form a knife edge at a front end).

Although not illustrated, both the first production device and the second production device may use a belt made of a flexible material to form a knife-edge-shaped fold (for example, another device or a transverse passage can be provided in a lower space).

A hardness of the sheet-shaped tofu T transferred from the continuous coagulation machine 10 is, for example, 1 kN/m² to 100 kN/m², or preferably 20 kN/m² to 10 kN/m². Tofu does not have a shape retaining property and transferring itself is difficult when the tofu is soft, whereas hard tofu is advantageous for transfer and transferring is easy when the tofu is too hard.

According to the tofu transfer mechanism 50 of the present embodiment, the distance between the continuous coagulation machine 10 and the continuous forming machine 30 is shortened, and the length of the transfer member 20 in the conveying direction is also shortened. Further, the difference in height between the continuous coagulation machine 10 and the continuous forming machine 30 can also be reduced and the inclination of the transfer member 20 can also be reduced. Therefore, it is possible to reduce the length and the height of the entire tofu continuous production device 1 and achieve space saving. As a result, for example, a space (height) occupied by the device in a factory can be reduced, a ceiling height can be lowered accordingly, construction cost can also be reduced, an amount of a steel material constituting the machine is also small, initial cost is reduced, and the device is excellent in economic efficiency.

By reducing the length of the transfer member 20 in the conveying direction and the inclination angle of the transfer member 20, the tofu can also be smoothly transferred, and the trouble such as the breakage of the tofu can also be prevented. It is also possible to reduce the water sprayed onto the transfer member 20. Even when the water is sprayed onto the transfer member 20, a small amount of water is required, the water can be saved, and an amount of discharged water can also be reduced to reduce burden on a purification tank. The device is economical because running cost is also reduced, for example, a work time and effort for performing fine adjustment on an amount of sprayed water according to a sliding condition of the tofu is reduced and work efficiency is improved.

Since the sliding resistance when the sheet-shaped tofu T passes through the transfer member 20 can be reduced, even soft tofu that is not hard tofu is also likely to pass through the transfer member 20 stably. Generally, in order to make the tofu hard, means such as increasing a concentration of soymilk or increasing an addition amount of a coagulant is used. When the addition amount of the coagulant is increased, secondary coagulation is performed by heat sterilization, an amount of separated water from the tofu tends to increase, and an umami taste thereof also tends to escape. According to the present invention, it is possible to appropriately control the addition amount of the coagulant, and it is possible to provide tofu that is slightly soft but has elasticity, is increased in water retention capacity, small in taste loss even after heat sterilization, more delicious, smooth and improved in texture. When there is a change in tofu quality due to a difference in tofu product type or a change in soybean quality, the sliding behavior (the sliding resistance) on the transfer member may change. However, since the transfer member is small (a transfer distance is short), it is difficult for the tofu to break down or to stop and accumulate, the tofu is not easily affected, and the trouble and the loss can also be reduced. Since the tofu has the water retention capacity, an improvement in yield is also expected especially when the tofu is pressed and compacted like the cotton tofu or the like.

The present invention is not limited to the above embodiments, and modifications, improvements, and the like are possible as appropriate. In addition, a material, a shape, a dimension, a numerical value, a form, the number, a disposition position, and the like of each of components in the above embodiments are not limited as long as the present invention can be achieved. The components in the above embodiments may be combined freely within a range not departing from the spirit of the present invention.

The present application is based on Japanese Patent Application No. 2020-082738 filed on May 8, 2020, the contents of which are incorporated herein by reference.

### REFERENCE SIGNS LIST

1: tofu continuous production device
10: continuous coagulation machine
20: transfer member
30: continuous forming machine
31: upper endless conveyor
32: lower endless conveyor
32a: folding-back surface
40: folding-back guide unit
42: folding-back unit
44: folding-back assisting unit
50: tofu transfer mechanism
60: cutting machine
61: cutting device
63: first cutting device
65: second cutting device
67: roll cutter
70: conveying machine
80: distribution and alignment machine
81: distribution and alignment device
V: virtual plane

1. A tofu transfer mechanism configured to transfer tofu from a first production device to a second production device in a tofu continuous production device, the tofu transfer mechanism comprising:
a transfer member disposed so as to bridge a terminal end of the first production device and a starting end of the second production device, the starting end of the second production device facing the terminal end of the first production device; and
a folding-back guide unit configured to guide an endless conveyor of the second production device at the starting end of the second production device such that the endless conveyor of the second production device is bent downward at an acute angle with respect to a conveyance surface on which the tofu is conveyed.

2. The tofu transfer mechanism according to claim 1,
wherein the folding-back guide unit comprises:
a folding-back unit configured to bend the endless conveyor of the second production device downward; and
a folding-back assisting unit disposed farther from the terminal end of the first production device than the folding-back unit and disposed below the folding-back unit, and
wherein the endless conveyor of the second production device bent by the folding-back unit is bridged over the folding-back assisting unit, so that the acute angle is maintained at a bent portion of the endless conveyor of the second production device at the folding-back unit.

3. The tofu transfer mechanism according to claim 2,
wherein an angle α formed by the conveyance surface of the endless conveyor of the second production device and a virtual plane is 90°<α<270°,
where the virtual plane is defined as a plane obtained by rotating a folding-back surface by 180 degrees about the folding-back unit, the folding-back surface extending from the folding-back unit toward the folding-back assisting unit.

4. The tofu transfer mechanism according to claim 2,
wherein the folding-back unit comprises a rotating roller or a fixing member.

5. The tofu transfer mechanism according to claim 4,
wherein a cross-sectional shape of the rotating roller is circular or polygonal.

6. The tofu transfer mechanism according to claim 4,
wherein the fixing member has a cross-sectional shape including at least a circular arc.

7. The tofu transfer mechanism according to claim 2,
wherein each of both ends of the folding-back unit has a tapered shape.

8. The tofu transfer mechanism according to claim 1,
wherein a conveyor of the first production device comprises any one of a metal belt, a Teflon belt, and a food belt.

9. The tofu transfer mechanism according to claim 1,
wherein the endless conveyor of the second production device comprises any one of a resin filter fabric belt, a Teflon belt, a food belt, and a wire net belt.

10. The tofu transfer mechanism according to claim 1,
wherein a hardness of the tofu transferred from the first production device is 1 kN/m² to 100 kN/m².

11. A tofu continuous production device comprising:
the tofu transfer mechanism according to claim 1;
the first production device; and
the second production device.

12. The tofu continuous production device according to claim 11,
wherein a rearmost end of the first production device and a foremost end of the second production device at the folding-back unit are close to each other in a horizontal direction or in contact with each other in the horizontal direction, or overlap with each other in the horizontal direction.

13. The tofu continuous production device according to claim 11, further comprising:
a cutting device on the first production device,
wherein the tofu is cut and then transferred to the endless conveyor of the second production device.

14. A tofu transfer mechanism configured to transfer tofu from a first production device to a second production device in a tofu continuous production device, the tofu transfer mechanism comprising:
a transfer member disposed so as to bridge a terminal end of the first production device and a starting end of the second production device, the starting end of the second production device facing the terminal end of the first production device; and
a folding-back guide unit configured to guide an endless conveyor of the first production device at the terminal end of the first production device such that the endless conveyor of the first production device is bent downward at an acute angle with respect to a conveyance surface on which the tofu is conveyed.

15. The tofu transfer mechanism according to claim 14,
wherein the folding-back guide unit comprises:
a folding-back unit configured to bend the endless conveyor of the first production device downward; and
a folding-back assisting unit disposed farther from the starting end of the second production device than the folding-back unit and disposed below the folding-back unit, and
wherein the endless conveyor of the first production device bent by the folding-back unit is bridged over the folding-back assisting unit, so that the acute angle is maintained at a bent portion of the endless conveyor of the first production device at the folding-back unit.

16. The tofu transfer mechanism according to claim 15,
wherein an angle α formed by the conveyance surface of the endless conveyor of the first production device and a virtual plane is 90°<α<270°,
where the virtual plane is defined as a plane obtained by rotating a folding-back surface by 180 degrees about the folding-back unit, the folding-back surface extending from the folding-back unit toward the folding-back assisting unit.

17. The tofu transfer mechanism according to claim 15,
wherein the folding-back unit comprises a rotating roller or a fixing member.

18. The tofu transfer mechanism according to claim 17,
wherein a cross-sectional shape of the rotating roller is circular or polygonal.

19. The tofu transfer mechanism according to claim 17,
wherein the fixing member has a cross-sectional shape including at least a circular arc.

20. The tofu transfer mechanism according to claim 15,
wherein each of both ends of the folding-back unit has a tapered shape.

21. The tofu transfer mechanism according to claim 14,
wherein a conveyor of the second production device comprises any one of a metal belt, a Teflon belt, a food belt, and a wire net belt.

22. The tofu transfer mechanism according to claim 14,
wherein a conveyor of the second production device is configured to convey the tofu in a direction intersecting with a tofu conveying direction of the first production device.

23. The tofu transfer mechanism according to claim 14,
wherein the endless conveyor of the first production device comprises any one of a resin filter fabric belt, a Teflon belt, a food belt, and a wire net belt.

24. The tofu transfer mechanism according to claim 14,
wherein a hardness of the tofu transferred from the first production device is 1 kN/m² to 100 kN/m².

25. A tofu continuous production device comprising:
the tofu transfer mechanism according to claim 14;
the first production device; and
the second production device.

26. The tofu continuous production device according to claim 25,
wherein a rearmost end of the first production device at the folding-back unit and a foremost end of the second production device are close to each other in a horizontal direction or in contact with each other in the horizontal direction, or overlap with each other in a horizontal direction.

27. The tofu continuous production device according to claim 25, further comprising:
a cutting device on the first production device,
wherein the tofu is cut and then transferred to an endless conveyor of the second production device.

28. A tofu continuous production device comprising:
a first production device comprising an endless conveyor; and
a second production device comprising an endless conveyor,
wherein the tofu continuous production device is configured to transfer tofu from the first production device to the second production device, and
wherein the tofu continuous production device further comprises:
a folding-back guide unit at an end of the production device, the end of the production device being one of a terminal end of the first production device and a starting end of the second production device, the starting end of the second production device facing the terminal end of the first production device, the folding-back guide unit being configured to guide the endless conveyor of the production device such that the endless conveyor of the production device is bent downward at an acute angle with respect to a conveyance surface on which the tofu is conveyed.

29. The tofu continuous production device according to claim 28, further comprising:
a transfer member disposed so as to bridge the terminal end of the first production device and the starting end of the second production device.

30. The tofu continuous production device according to claim 28,
wherein the folding-back guide unit comprises:
a folding-back unit configured to bend the endless conveyor of the second production device downward; and
a folding-back assisting unit disposed farther from the terminal end of the first production device than the folding-back unit and disposed below the folding-back unit, and
wherein the endless conveyor of the second production device bent by the folding-back unit is bridged over the folding-back assisting unit, so that the acute angle is maintained at a bent portion of the endless conveyor of the second production device at the folding-back unit.

31. The tofu continuous production device according to claim 28,
wherein the folding-back guide unit is provided at the starting end of the second production device,
wherein the first production device is a continuous coagulation machine in which the endless conveyor comprises any one of a metal belt, a Teflon belt, and a food belt, and
wherein the second production device is any one of a continuous forming machine, a cutting machine, a conveying machine, and a distribution and alignment machine, in which the endless conveyor comprises any one of a resin filter fabric belt, a Teflon belt, a food belt, and a wire net belt.

32. The tofu continuous production device according to claim 28,
wherein the folding-back guide unit is provided at the terminal end of the first production device,
wherein the first production device is a continuous forming machine in which the endless conveyor comprises any one of a resin filter fabric belt, a Teflon belt, a food belt, and a wire net belt, and
wherein the second production device is any one of a cutting machine, a conveying machine, and a distribution and alignment machine, in which the endless conveyor comprises any one of a metal belt, a resin filter fabric belt, a Teflon belt, a food belt, and a wire net belt.

33. The tofu continuous production device according to claim 28, further comprising:
a third production device comprising an endless conveyor,
wherein the tofu is transferred from the second production device to the third production device, and
wherein the tofu continuous production device further comprises another folding-back guide unit at an end of the production device, the end of the production device being one of a terminal end of the second production device and a starting end of the third production device, the starting end of the third production device facing the terminal end of the second production device, the another folding-back guide unit being configured to guide the endless conveyor of the production device such that the endless conveyor of the production device is bent downward at an acute angle with respect to a conveyance surface on which the tofu is conveyed.

34. The tofu continuous production device according to claim 33,
wherein the folding-back guide unit is provided at the starting end of the second production device, and the another folding-back guide unit is provided at the terminal end of the second production device,
wherein the first production device is a continuous coagulation machine in which the endless conveyor comprises any one of a metal belt, a Teflon belt, and a food belt,
wherein the second production device is a continuous forming machine in which the endless conveyor comprises any one of a resin filter fabric belt, a Teflon belt, a food belt, and a wire net belt, and
wherein the third production device is any one of a cutting machine, a conveying machine, and a distribution and alignment machine, in which the endless conveyor comprises any one of a metal belt, a resin filter fabric belt, a Teflon belt, a food belt, and a wire net belt.

35. The tofu continuous production device according to claim 28,
wherein the endless conveyor of the first production device is a first endless conveyor,
wherein the endless conveyor of the second production device is a second endless conveyor,
wherein the tofu continuous production device is configured to transfer, from the first endless conveyor to the second endless conveyor, the tofu for which a production process conducted at the first production device has been completed, and then conduct a production process for the tofu at the second production device,
wherein the first production device comprises a first drive roller provided on a side of the second endless conveyor, the first drive roller being configured to drive the first endless conveyor,
wherein the folding-back guide unit is provided in the second production device on a side of the first endless conveyor, the folding-back guide unit being configured to contact a back surface of a conveyance surface of the second endless conveyor and fold back the conveyance surface in a knife edge shape,
wherein the second production device further comprises a folding-back assisting unit provided at a position farther from the first endless conveyor than the folding-back guide unit, the folding-back assisting being configured to contact a front surface of the conveyance surface and change a traveling direction of the conveyance surface,
wherein a height position of the folding-back guide unit as viewed from a horizontal direction is located between a center of the first drive roller and a conveyance surface of the first endless conveyor or at a same height as the conveyance surface of the first endless conveyor, and
wherein a position of the folding-back guide unit as viewed from above is located at a position overlapping with the first drive roller.

36. The tofu continuous production device according to claim 28,
wherein the endless conveyor of the first production device is a first endless conveyor,
wherein the endless conveyor of the second production device is a second endless conveyor,
wherein the tofu continuous production device is configured to transfer, from the first endless conveyor to the second endless conveyor, the tofu for which a production process conducted at the first production device has been completed, and then conduct a production process for the tofu at the second production device,
wherein the second production device comprises a second drive roller provided on a side of the first endless conveyor, the second drive roller being configured to drive the second endless conveyor,
wherein the folding-back guide unit is provided in the first production device on a side of the second endless conveyor, the folding-back guide unit being configured to contact a back surface of a conveyance surface of the first endless conveyor and fold back the conveyance surface in a knife edge shape,
wherein the first production device further comprises a folding-back assisting unit provided at a position farther from the second endless conveyor than the folding-back guide unit, the folding-back assisting being configured to contact a front surface of the conveyance surface and change a traveling direction of the conveyance surface,
wherein a height position of the folding-back guide unit as viewed from a horizontal direction is located at a same height as a conveyance surface of the second endless conveyor, and
wherein a position of the folding-back guide unit as viewed from above is located at a position overlapping with the second drive roller.
